(19) United States
(12) Patent Application Publication
(10) Pub. No.: US 2025/0209544 A1
(43) Pub. Date: Jun. 26, 2025

(54) CONTENT EVENT MANAGER FOR PROVIDING CONTENT EVENTS BASED ON RELEVANCE SCORES

(71) Applicant: Microsoft Technology Licensing, LLC, Redmond, WA (US)

(72) Inventors: Tammy KONG, San Francisco, CA (US); Rakesh MALLADI, San Jose, CA (US); Naman GOEL, San Jose, CA (US); Netra MALAGI, San Jose, CA (US); Berardino F. PEZZUTI, San Jose, CA (US); Shipeng YU, San Jose, CA (US); Xukai WANG, San Jose, CA (US); Rishav ROY CHOWDHURY, Toronto (CA); Jingshu HUANG, Los Altos, CA (US); Chinmayee Nitin VAIDYA, Sunnyvale, CA (US); Dan NI, San Jose, CA (US); Hesong HUANG, San Jose, CA (US); Elan Ariel MELTSNER, Brooklyn, NY (US)

(73) Assignee: Microsoft Technology Licensing, LLC, Redmond, WA (US)

(21) Appl. No.: 18/395,153

(22) Filed: Dec. 22, 2023

(51) Int. Cl. G06Q 50/00

(52) U.S. Cl. CPC G06Q 50/01

(57) ABSTRACT

Systems and methods for providing content events that are relevant to a first user of a social network are provided. In particular, a computing device may obtain content data associated with one or more content events, obtain user engagement data associated with the first user, determine a relevance score for each of the one or more content events using a relevance predictive model based on the user engagement data and attributes associated with the respective content event, the relevance score of each of the one or more content events representing a likelihood of the first user to engage with the respective content event, ranking the content events based on the relevance score for each of the one or more content events, and presenting a subset of the content events to the first user on a user interface of a device based on the ranking.

### BACKGROUND

Social networking service platforms allow users to connect with others in their industry, share their work and accomplishments, stay up-to-date on the latest industry news and trends, and explore new opportunities. While these platforms are helpful in connecting with other professionals and growing their network in their industry, given the potential volume of connections and content, it may be challenging for users to have meaningful interactions with those individuals more important to them.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with examples of the present disclosure, a content event manager provides a list of nurture events selected from a plurality of content events related to connections (“viewee”) that are most relevant to the user (“viewer”) on a unique destination page of a social network where viewer can find noteworthy opportunities to strengthen desired connections in the social network. To identify the relevant nurture events, a machine learning model is used to determine which content events are more relevant to the viewer by ranking the content events based on user engagement data (e.g., connection strength, notification affinity, and/or feed affinity) and one or more attributes associated with the corresponding content event (e.g., a type of content event). For example, the content events include celebrations (e.g., birthdays, job changes, work anniversaries), milestones (e.g., promotions), and social hiring. In other words, the viewer is presented with the relevant “noteworthy” nurture events that are related to those viewees in the network that the viewer is more likely to engage with. By doing so, the viewer can focus on nurturing the relationships with specific connections within the social network.

In accordance with at least one example of the present disclosure, a method for providing content events that are relevant to a first user of a social network is provided. The method includes obtaining content data associated with one or more content events, each of the one or more content events related to one or more second users within the social network, the first user connected with the one or more second users within the social network, obtaining user engagement data associated with the first user, the user engagement data indicative of interactions between the first user and content generated by one or more third users of the social network, determining a relevance score for each of the one or more content events using a relevance predictive model based on the user engagement data and attributes associated with the respective content event, the relevance score of each of the one or more content events representing a likelihood of the first user to engage with the respective content event, ranking the content events based on the relevance score for each of the one or more content events, and presenting a subset of the content events to the first user on a user interface of a device based on the ranking.

In accordance with at least one example of the present disclosure, a computing device for providing content events that are relevant to a first user of a social network is provided. The computing device may include a processor and a memory having a plurality of instructions stored thereon that, when executed by the processor, causes the computing device to obtain content data associated with one or more content events, each of the one or more content events related to one or more second users within the social network, the first user connected with the one or more second users within the social network, obtain user engagement data associated with the first user, the user engagement data indicative of interactions between the first user and content generated by one or more third users of the social network, determine a relevance score for each of the one or more content events using a relevance predictive model based on the user engagement data and attributes associated with the respective content event, the relevance score of each of the one or more content events representing a likelihood of the first user to engage with the respective content event, rank the content events based on the relevance score for each of the one or more content events, and present a subset of the content events to the first user on a user interface of a device based on the ranking.

In accordance with at least one example of the present disclosure, a non-transitory computer-readable medium storing instructions for providing content events that are relevant to a first user of a social network is provided. The instructions when executed by one or more processors of a computing device, cause the computing device to obtain content data associated with one or more content events, each of the one or more content events related to one or more second users within the social network, the first user connected with the one or more second users within the social network, obtain user engagement data associated with the first user, the user engagement data indicative of interactions between the first user and content generated by one or more third users of the social network, determine a relevance score for each of the one or more content events using a relevance predictive model based on the user engagement data and attributes associated with the respective content event, the relevance score of each of the one or more content events representing a likelihood of the first user to engage with the respective content event, rank the content events based on the relevance score for each of the one or more content events, and present a subset of the content events to the first user on a user interface of a device based on the ranking.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following FIGS.

FIG. 1 depicts a block diagram of an example of an operating environment in which a content event manager may be implemented in accordance with examples of the present disclosure;

FIG. 2 depicts a block diagram of an example of an operating environment in which a content event manager may be implemented in accordance with examples of the present disclosure;

FIGS. 3A and 3B depict a flowchart of an example method of providing relevant nurture events to a viewer of a social network in accordance with examples of the present disclosure;

FIGS. 4A and 4B depict a flowchart of an example method of presenting new relevant nurture events on a nurture page of a social network in accordance with examples of the present disclosure;

FIG. 5 depicts a flowchart of an example method of presenting badge counts to a viewer of a social network in accordance with examples of the present disclosure;

FIGS. 6A-10B depict screenshots of a user interface of a social network app in accordance with examples of the present disclosure;

FIGS. 11A and 11B illustrate overviews of an example generative machine learning model that may be used in accordance with examples of the present disclosure;

FIG. 12 is a block diagram illustrating example physical components of a computing device with which aspects of the disclosure may be practiced;

FIG. 13 is a simplified block diagram of a computing device with which aspects of the present disclosure may be practiced; and

FIG. 14 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Social networking service platforms allow users to connect with others in their industry, share their work and accomplishments, stay up-to-date on the latest industry news and trends, and explore new opportunities. While these platforms are helpful in connecting with other professionals and growing their network in their industry, given the potential volume of connections and content, it may be challenging for users to have meaningful interactions with those individuals more important to them.

In accordance with examples of the present disclosure, to strengthen desired connections within a social network, a unique destination (also referred to as a nurture page) is created in the platform where users can find noteworthy opportunities. Specifically, a content event manager provides a list of nurture events selected from a plurality of content events related to connections (“viewees”) that are most relevant to the user (“viewer”) on the unique destination page. For example, the content event is deemed relevant to the viewer if there is a high probability that the viewer will engage with the corresponding nurture event. To identify the relevant nurture events, a machine learning model is used to determine which content events are more relevant to the viewer by ranking the content events based on user engagement data (e.g., connection strength, notification affinity, and/or feed affinity) and one or more attributes associated with the corresponding content event (e.g., a type of content event). For example, the content events include celebrations (e.g., birthdays, job changes, work anniversaries), milestones (e.g., promotions), and social hiring. In other words, the viewer is presented with the relevant “noteworthy” nurture events that are related to those viewees in the network that the viewer is more likely to engage with. By doing so, the viewer can focus on nurturing the relationships with specific connections within the social network.

In accordance with examples of the present disclosure, the connections within the social network include different types of connections between the viewer and the viewees in the social network. For example, the types of connections include first-degree connections, second-degree connections, and third-degree connections. The first-degree connections are those viewees that the viewer is directly connected to, the second-degree connections are those viewees who are connected to the viewer's first-degree connections, and the third-degree connections are those viewees who are connected to the viewer's second-degree connections. In some embodiments, the types of connections further include followers who follow the viewer's public updates and fellow members of the user's groups within the social network. In other words, the viewees within the social network may be directly or indirectly connected to the viewer. Moreover, the types of connections impact connection strength between the viewer and a respective viewee and the likelihood of nurturing that relationship. Additionally, in some embodiments, the viewees may be entities (e.g., organizations, companies, topics, industries). For example, the viewer may have followed a particular company, which may infer that the viewer is interested in nurturing that relationship with the company. Similarly, the viewer may indicate a specific interest in following a particular topic (e.g., related to prompt engineering), which may infer that the viewer is interested in nurturing that interest. Moreover, it should be appreciated that there may not be any prior historical engagement between the viewer and a viewee associated with a nurture event, and the user engagement data across commonalities (e.g., shared topics, shared connections) may help drive engagement.

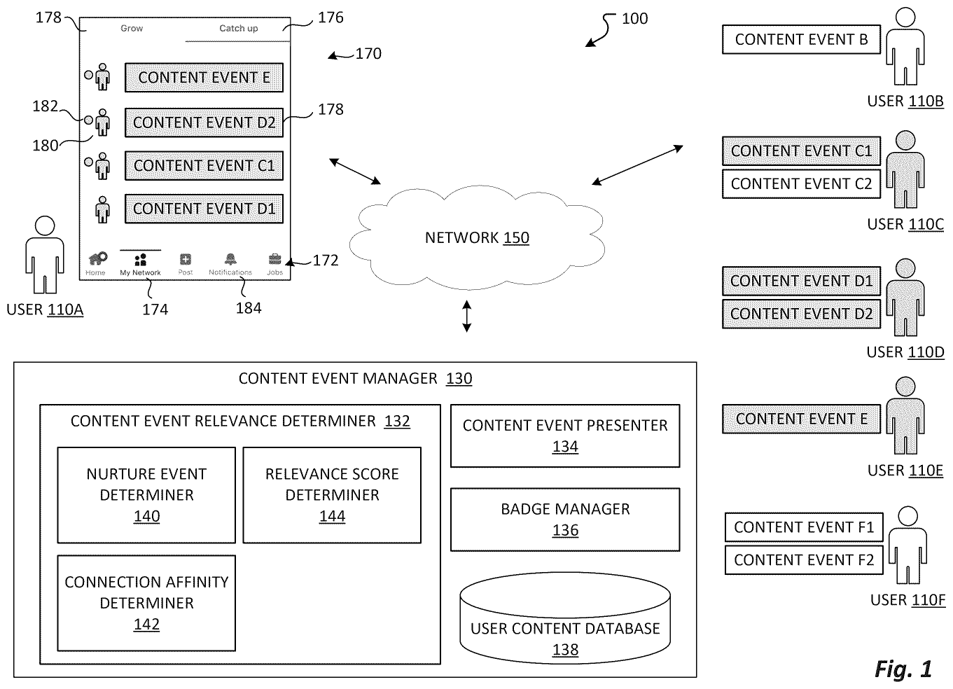

For example, as illustrated in FIG. 1, user 110A is a viewer of a user interface 170 of a social network app on a mobile device of the user 110A, and user 110B, user 110C, user 110D, user 110E, and user 110F are user 110A's connections within the social network. It should be appreciated that the users 110B-F may be directly (e.g., first-degree connections) or indirectly connected (e.g., second- and third-degree connections) to the user 110A, and the user 110A may not have any prior historical engagement with one or more users 110B-F. In the illustrative embodiment, content events B, C1, C2, D1, D2, E, F1, and F2 are new content events that are related to the connections within the user 110A's network. The content events include any activities that are related to the users 110B-F in the social network. For example, the content events may include celebrations, milestones, social hiring, open to work, feeds, messages, or any type of activities or contents related to the users 110B-F. As shown in FIG. 1, content event B is related to user 110B, content events C1 and C2 are related to user 110C, content events D1 and D2 are related to user 110D, content event E is related to user 110E, and content events F1 and F2 are related to user 110F. As described further below, a subset of content events (referred to as the “nurture events”) are selected from the content events (i.e., content events B, C1, C2, D1, D2, E, F1, and F2) that the user 110A may find noteworthy opportunities to reach out to the users 110B-110F.

When the user 110A is logged into the social network, the user 110A can select “My Network” tab 174 from a menu bar 172 to manage connections in the social network. My Network tab 174 is further divided into two tabs, “Grow” tab 178 and “Catch up” tab 176. Grow tab 178 focuses on growing connections in the social network, and Catch up tab 176 focuses on nurturing connections in the user 110A's network within the social network. The exemplary user interface 170 is presented to the user 110A when the user 110A clicks on Catch up tab 176. It should be appreciated that, in some embodiments, “Notifications” tab 184 may be split from “My Network” tab.

Under Catch up tab 176, a list of nurture events related to connections (e.g., users 110B-F) that are most relevant to the user 110A is presented to the user 110A. As described further below, to identify the relevant nurture events, a machine learning model is used to determine which nurture events are more relevant to the user 110A by ranking the nurture events based on user engagement data (e.g., connection strength, notification affinity, and/or feed affinity) and one or more attributes associated with the corresponding nurture event (e.g., a type of nurture event). For example, the nurture events include celebrations (e.g., birthdays, job changes, work anniversaries), milestones (e.g., promotions), and social hiring. In other words, the user 110A is presented with the relevant “noteworthy” nurture events that are related to the users 110B-F in the network that the user 110A is more likely to engage with. As shown in the user interface 170, the nurture events (e.g., content events C1, D1, D2, and E) are highlighted to indicate that the nurture events are new (e.g., has not previously presented, seen, or otherwise read by the user 110A).

Additionally, a subset of the new nurture events may be badged with an indicator 182 next to a profile icon 180 of the corresponding user in the user interface 170. As described further below, the new nurture events are badged if they are considered to be highly relevant to the viewer's user experience. For example, as described above, the new nurture events that satisfy the predefined badging condition (e.g., a particular type of nurture event) and the relevance condition (e.g., exceeding a predetermined relevance score) are badged. As shown in FIG. 1, only content events C1, D2, and E satisfy the predefined badging condition and are marked with a dot indicator 182. The new nurture events that are badged are sorted in the order of relevance score. In this example, the relevance score of content event E is greater than the relevance score of content event D2, and the relevance score of content event D2 is greater than the relevance score of content event C1. Hence, the nurture events are presented to the viewer in the order of content event E, content event D2, and content event C1.

It should be appreciated that content event D1 is presented to the viewer because it is determined to be a new nurture event. However, the content event D1 is not badged because it does not satisfy the predefined badging condition (e.g., a particular type of nurture event) and/or the predefined relevance condition (e.g., exceeding a predetermined relevance score). As such, content event D1 is presented below the new badged nurture events. If there are more than one new nurture event that are not badged, those nurture events are sorted in the order of relevance score. In other words, the new nurture events that are not badged are presented below the badged new nurture events.

FIG. 1 depicts a block diagram of an example of an operating environment 100 in which a content event manager 130 may be implemented in accordance with examples of the present disclosure. To do so, the operating environment 100 includes a content event manager 130 that is executed on a platform server associated with a social network. The social network is a website or app that allows users to connect with each other on a common platform. The content event manager 130 is communicatively coupled to a plurality of computing devices of the users 110 via a network 150. The network 150 may include any kind of computing network including, without limitation, a wired or wireless local area network (LAN), a wired or wireless wide area network (WAN), and/or the Internet.

The content event manager 130 is configured to provide content events that a user (“viewer”) may find noteworthy opportunities to reach out to connections (“viewees”) on a unique destination page in the social network. In the illustrative embodiment, the viewees are within a user network of the viewer within the social network. To do so, the content event manager 130 includes a content event relevance determiner 132, a content event presenter 134, and a badge manager 136. The content event relevance determiner 132 is configured to determine whether content events related to viewees are relevant to the viewer. The content events include any activities that are related to the viewees. For example, the types of content events include celebrations, milestones, social hiring, open to work, feeds, messages, or any type of activities or contents related to viewees. To do so, the content event relevance determiner 132 further includes a nurture event determiner 140, a connection affinity determiner 142, and a relevance score determiner 144.

The nurture event determiner 140 is configured to determine nurture events from the content events related to the viewees. The nurture events are a subset of the content events that are associated with activities of viewees that provide noteworthy opportunities for the viewer to start an interaction with the viewees. To do so, the nurture event determiner 140 is configured to select or identify nurture events from the content events based on the particular types of content events. For example, the types of content events selected as the nurture events may include birthdays, job changes, work anniversaries, promotions, trending content, education completion, mentioned in news, social hiring, open to work, feeds, messages, or any noteworthy activities or contents related to a viewee. It should be appreciated that the nurture events are stored in a user content database 138. In some embodiments, the user content database 138 may be a remotely coupled to the content event manager 130.

The connection affinity determiner 142 is configured to determine a connection affinity between the viewer and each of the viewee. It should be appreciated that the connection affinity is also referred to as an affinity score between the viewer and each of the viewee in the present application. For example, the connection affinity between the viewer and a respective viewee increases as activities between the viewer and the respective viewee increases (e.g., more clicks on notifications or feeds related to the respective viewee). In other words, the more the viewer engages with content related to the respective viewee, the stronger the connection affinity becomes.

The connection affinity determiner 142 is configured to determine the connection affinity based on engagement data associated with the viewer. For example, the engagement data indicates one or more engagement metrics of the viewer. For example, the one or more engagement metrics include a number of clicks, click through rates (CTR), engagement times, shares, comments, reactions, or any other metrics that represent activities of the viewer on the social network. For example, according to some embodiments, the engagement data includes a connection feature, a notification affinity feature, and/or a feed affinity feature. The connection feature indicates connection strength between the viewer and one or more members of the social network. For example, the connection strength between the viewer and a viewee is determined based on a type of connection between the viewer and the viewee and any activities of the viewer that indicate interactions with one or more content events from the viewee. However, it should be appreciated that, in some cases, there may not be any prior historical engagement between the viewer and the viewee, and in such cases, the engagement data across commonalities (e.g., shared topics, shared connections) may be used to determine the connection strength. The notification affinity feature indicates interactions between the viewer and one or more notifications generated by a respective member of the one or more members of the social network during a predefined time period (e.g., last 90 days). In other words, the notification affinity between the viewer and a member of the one or more members corresponds to a number of clicks that the viewer engaged with one or more notifications related to the respective member. Additionally, in some embodiments, the notification affinity feature includes interactions between the viewer and one or more notifications generated by an entity (e.g., organizations, companies, topics, industries). For example, the viewer may follow a particular company or a particular topic. The feed affinity feature indicates interactions between the viewer and one or more feeds generated by a respective member of the one or more members of the social network during a predefined time period (e.g., last 180 days). In other words, the feed affinity between the viewer and a member of the one or more members corresponds to a number of clicks that the viewer engaged with one or more feeds related to the respective member. In some embodiments, the engagement data may also include other affinity features that represent activities or engagement of the viewer on different platforms or applications (e.g., one or more different social network platforms).

The relevance score determiner 144 is configured to determine a relevance score for each nurture event using a relevance model based on the connection affinity. The relevance model is one or more machine learning models, including a large language model (LLM), a deep neural network model, a regression model, other type of machine learning models, or a combination of models. The relevance score represents a likelihood of viewer to engage with the corresponding nurture event. According to some embodiments, in addition to the connection affinity, the user objective is also used to determine the relevance score for each nurture event using the relevance model. To do so, the relevance score determiner 144 is further configured to determine a viewer objective of the viewer by analyzing the engagement data associated with the viewer. The viewer objective (e.g., job-to-be-done) of the viewer represents what the viewer is trying to achieve or accomplish by engaging or being active on the social network. For example, the user objective may be finding a new career, nurturing more meaningful connections in a particular industry, or helping others in the social network. In some embodiments, the relevance score determiner 144 is configured to predict the viewer objective using one or more machine learning model.

Content event presenter 134 is configured to retrieve and present new relevant nurture events on a nurture page of a social network. To do so, the content event presenter 134 is configured to determine a relevant category for each new nurture event by obtaining all new nurture events from the user content database 138. Each nurture event has a status flag that indicates whether the nurture event has been presented to the viewer. For example, the status flag is set to a first flag if the corresponding nurture event has not previously presented to or seen by the viewer (i.e., “new” content event) and is set to a second flag if the corresponding nurture event has been presented, seen, or otherwise read by the viewer.

The content event presenter 134 is configured to determine whether the event type of the corresponding new nurture event satisfies a predefined badging condition and/or a predefined relevance condition. The predefined badging condition defines whether a particular type of nurture events should be notified to the viewer. For example, the predefined badging condition is whether the type of the corresponding new nurture event is at least one of the predefined types of content event. According to some embodiments, the viewer can indicate what types of nurture events that the viewer wants to be notified of. For example, the viewer can turn on or off a badging setting of a particular type of nurture events. In other words, a new nurture event that has the badging setting turned off is deemed not interested by the viewer and, thus, is not notified to the viewer. However, it should be appreciated that such new nurture event is still presented on the nurture page for the viewer (e.g., content event D1).

The predefined relevance condition defines whether each new nurture event is deemed highly relevant to the viewer's user experience. For example, the predefined relevance condition is whether the relevance score of the corresponding new nurture event exceeds a predefined relevance score threshold (e.g., whether the new nurture event should be badged for notifying the viewer). In other words, for each new nurture event, the content event presenter 134 is configured to determine whether the relevance score of the corresponding new nurture event exceeds the predefined relevance score threshold. It should be appreciated that the relevance score threshold may be predefined by the social network platform, defined by the viewer, and/or determined using one or more machine learning models. In some embodiments, the viewer may further define a type of nurture event and filter the new nurture events that exceeds the predefined relevance threshold.

The content event presenter 134 is configured to categorize one or more new nurture events that do not satisfy the predefined badging condition in a low relevant category, one or more new nurture events satisfy the predefined badging condition but not the predefined relevance condition in a medium relevant category, and one or more new nurture events satisfy both the predefined badging condition and the predefined relevance condition in a high relevant category.

The content event presenter 134 is configured to present the new nurture events to the viewer in the order of relevance. For example, if there are at least one new nurture event in each relevant category, the content event presenter 134 is configured to present the new nurture events from the high relevant category in a descending order of relevance score with a relevance indicator (e.g., a dot indicator 182). The content event presenter 134 is configured to present the new nurture events from the medium relevant category in a descending order of relevance score after the new nurture events from the high relevant category. Lastly, the content event presenter 134 is configured to present the new nurture events from the low relevant category in a descending order of relevance score after the new nurture events from the high and medium relevant categories. It should be appreciated that, in some embodiments, the nurture events may be divided into fewer or more than three categories (e.g., high, medium, and low) described herein.

The badge manager 136 is configured to determine whether a badge count for a nurture tab should be updated. For example, the badge manager 136 is configured to detect a predefined badge update condition that triggers retrieval of new nurture events and/or update of a badge count. For example, detecting the predefined badge update condition includes receiving an indication that a viewer has logged into the social network via a social network app or a social network website, receiving an indication that the viewer has opened or reopened the social network app where the viewer is already logged in, and/or detecting a predefined time period has passed since the last badge update.

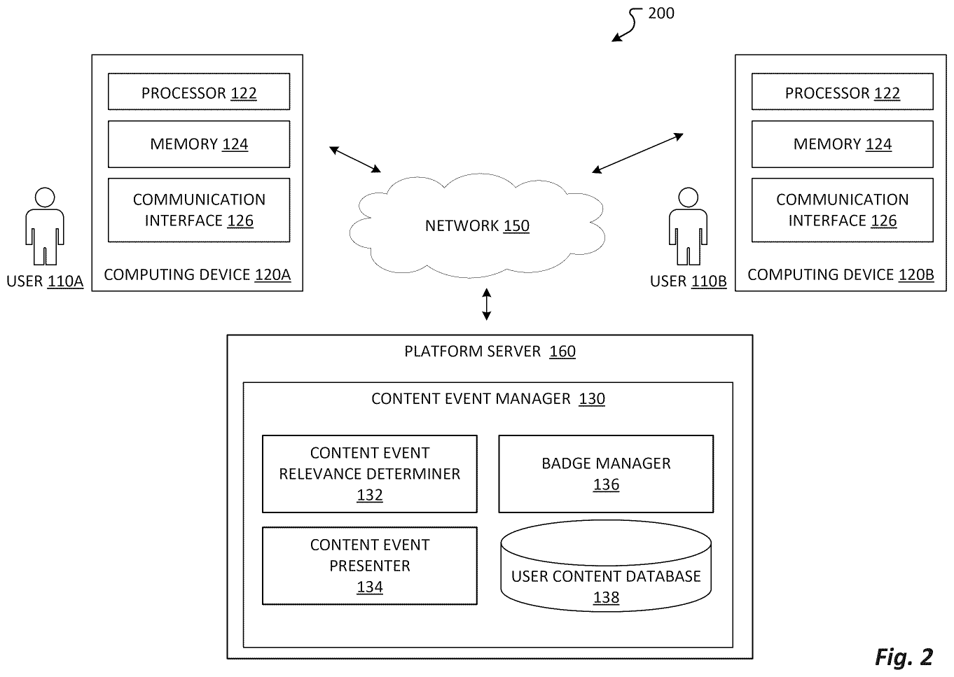

Referring now to FIG. 2, a block diagram of an example of an operating environment 200 in which a content event manager may be implemented in accordance with examples of the present disclosure is provided. As shown in FIG. 2, similar elements have the same reference number as shown in FIG. 1. To do so, the operating environment 200 includes a computing device 120 associated with the user 110 for accessing a social networking service. The operating environment 200 may further include one or more remote devices, such as a social network platform server 160, that are communicatively coupled to the computing device 120 via a network 150. The network 150 may include any kind of computing network including, without limitation, a wired or wireless local area network (LAN), a wired or wireless wide area network (WAN), and/or the Internet.

The computing device 120 includes one or more programs for accessing the social networking service executing on the computing device 120 having a processor 122, a memory 124, and a communication interface 126. For example, the social networking service may be accessed via a social network app or a social network website. The computing device 120 may be, but is not limited to, a computer, a notebook, a laptop, a mobile device, a smartphone, a tablet, a portable device, a wearable device, or any other suitable computing device that is capable of executing the content event manager 130. In some embodiments, one or more processes may be performed on the computing device 120 in addition to via the network 150.

The platform server 160 is commutatively coupled to the computing devices 120 of users 110 to provide the social networking service to allow the users 110 to connect with others in the social network. To do so, the platform server 160 includes a content event manager 130. The content event manager 130 is configured to provide content events that a user (“viewer”) may find noteworthy opportunities to reach out to connections (“viewees”) on a unique destination page in the social network. In the illustrative embodiment, the viewees are within a user network of the viewer within the social network. To do so, the content event manager 130 includes a content event relevance determiner 132, a content event presenter 134, and a badge manager 136.

The content event relevance determiner 132 is configured to determine whether content events related to viewees are relevant to the viewer. The content events include any activities that are related to the viewees. For example, the types of content events include celebrations, milestones, social hiring, open to work, feeds, messages, or any type of activities or contents related to viewees. The content event relevance determiner 132 is configured to determine nurture events from the content events related to the viewees. The nurture events are a subset of the content events that are associated with activities of viewees that provide noteworthy opportunities for the viewer to start an interaction with the viewees. To do so, the content event relevance determiner 132 is configured to select or identify nurture events from the content events based on the particular types of content events. For example, the types of content events selected as the nurture events may include birthdays, job changes, work anniversaries, promotions, trending content, education completion, mentioned in news, social hiring, open to work, feeds, messages, or any noteworthy activities or contents related to a viewee.

The content event relevance determiner 132 is configured to determine a connection affinity between the viewer and each of the viewee. It should be appreciated that the connection affinity is also referred to as an affinity score between the viewer and each of the viewee in the present application. For example, the connection affinity between the viewer and a respective viewee increases as activities between the viewer and the respective viewee increases (e.g., more clicks on notifications or feeds related to the respective viewee). In other words, the more the viewer engages with content related to the respective viewee, the stronger the connection affinity becomes. To do so, the content event relevance determiner 132 is configured to determine the connection affinity based on engagement data associated with the viewer. For example, the engagement data indicates one or more engagement metrics of the viewer. For example, the one or more engagement metrics include a number of clicks, click through rates (CTR), engagement times, shares, comments, reactions, or any other metrics that represent activities of the viewer on the social network.

According to some aspects of the present invention, the engagement data further includes a connection feature, a notification affinity feature, and/or a feed affinity feature. The connection feature indicates connection strength between the viewer and one or more members of the social network. The notification affinity feature indicates interactions between the viewer and one or more notifications generated by a respective member of the one or more members of the social network during a predefined time period (e.g., last 90 days). In other words, the notification affinity between the viewer and a member of the one or more members corresponds to a number of clicks that the viewer engaged with one or more notifications related to the respective member. The feed affinity feature indicates interactions between the viewer and one or more feeds generated by a respective member of the one or more members of the social network during a predefined time period (e.g., last 180 days). In other words, the feed affinity between the viewer and a member of the one or more members corresponds to a number of clicks that the viewer engaged with one or more feeds related to the respective member. In some embodiments, the engagement data may also include other affinity features that represent activities or engagement of the viewer on different platforms or applications (e.g., one or more different platforms associated with the social network platform).

The content event relevance determiner 132 is configured to determine a relevance score for each nurture event using a relevance model based on the connection affinity. The relevance model is one or more machine learning models, including a large language model (LLM), a deep neural network model, a regression model, other type of machine learning models, or a combination of models. The relevance score represents a likelihood of viewer to engage with the corresponding nurture event. According to some embodiments, in addition to the connection affinity, the user objective is also used to determine the relevance score for each nurture event using the relevance model.

To do so, the content event relevance determiner 132 is further configured to determine a viewer objective of the viewer by analyzing the engagement data associated with the viewer. The viewer objective (e.g., job-to-be-done) of the viewer represents what the viewer is trying to achieve or accomplish by engaging or being active on the social network. For example, the user objective may be finding a new career, nurturing more meaningful connections in a particular industry, or helping others in the social network. In some embodiments, the content event relevance determiner 132 is configured to predict the viewer objective using one or more machine learning model.

Content event presenter 134 is configured to retrieve and present new relevant nurture events on a nurture page of a social network. To do so, the content event presenter 134 is configured to determine a relevant category for each new nurture event by obtaining all new nurture events from the user content database 138. Each nurture event has a status flag that indicates whether the nurture event has been presented to the viewer. For example, the status flag is set to a first flag if the corresponding nurture event has not previously presented to or seen by the viewer (i.e., “new” content event) and is set to a second flag if the corresponding nurture event has been presented, seen, or otherwise read by the viewer.

The content event presenter 134 is configured to determine whether the event type of the corresponding new nurture event satisfies a predefined badging condition and/or a predefined relevance condition. The predefined badging condition defines whether a particular type of nurture events should be notified to the viewer. For example, the predefined badging condition is whether the type of the corresponding new nurture event is at least one of the predefined types of content event. According to some embodiments, the viewer can indicate what types of nurture events that the viewer wants to be notified of. For example, the viewer can turn on or off a badging setting of a particular type of nurture events. In other words, a new nurture event that has the badging setting turned off is deemed not interested by the viewer and, thus, is not notified to the viewer. However, it should be appreciated that such new nurture event is still presented on the nurture page for the viewer.

The predefined relevance condition defines whether each new nurture event is deemed highly relevant to the viewer's user experience. For example, the predefined relevance condition is whether the relevance score of the corresponding new nurture event exceeds a predefined relevance score threshold (e.g., whether the new nurture event should be badged for notifying the viewer). In other words, for each new nurture event, the content event presenter 134 is configured to determine whether the relevance score of the corresponding new nurture event exceeds the predefined relevance score threshold. It should be appreciated that the relevance score threshold may be predefined by the social network platform, defined by the viewer, and/or determined using one or more machine learning models. In some embodiments, the viewer may further define a type of nurture event and filter the new nurture events that exceeds the predefined relevance threshold.

The content event presenter 134 is configured to categorize one or more new nurture events that do not satisfy the predefined badging condition in a low relevant category, one or more new nurture events satisfy the predefined badging condition but not the predefined relevance condition in a medium relevant category, and one or more new nurture events satisfy both the predefined badging condition and the predefined relevance condition in a high relevant category.

The content event presenter 134 is configured to present the new nurture events to the viewer in the order of relevance. For example, if there are at least one new nurture event in each relevant category, the content event presenter 134 is configured to present the new nurture events from the high relevant category in a descending order of relevance score with a relevance indicator. The content event presenter 134 is configured to present the new nurture events from the medium relevant category in a descending order of relevance score after the new nurture events from the high relevant category. Lastly, the content event presenter 134 is configured to present the new nurture events from the low relevant category in a descending order of relevance score after the new nurture events from the high and medium relevant categories.

The badge manager 136 is configured to determine whether a badge count for a nurture tab should be updated. For example, the badge manager 136 is configured to detect a predefined badge update condition that triggers retrieval of new nurture events and/or update of a badge count. For example, detecting the predefined badge update condition includes receiving an indication that a viewer has logged into the social network via a social network app or a social network website, receiving an indication that the viewer has opened or reopened the social network app where the viewer is already logged in, and/or detecting a predefined time period has passed since the last badge update.

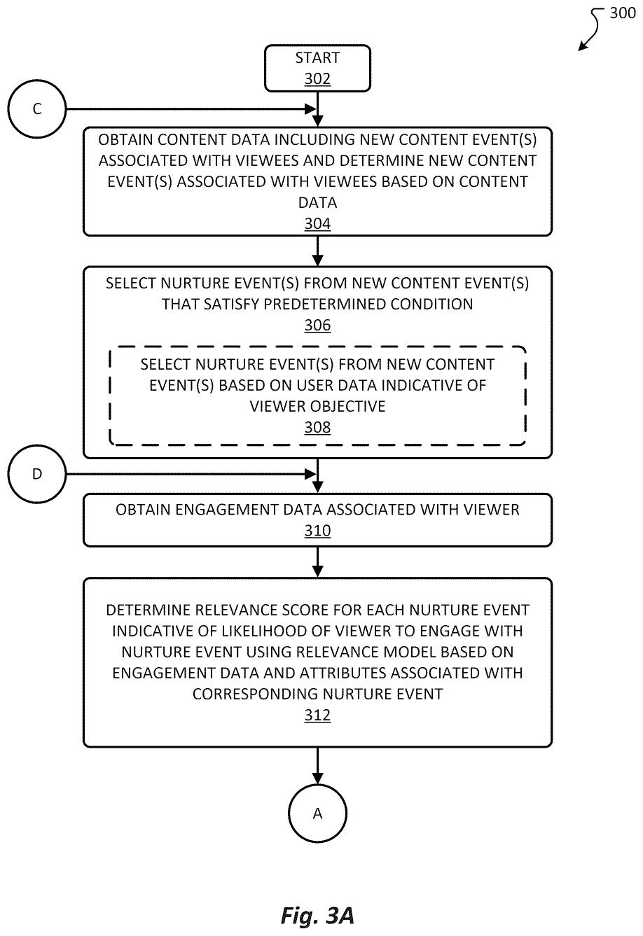

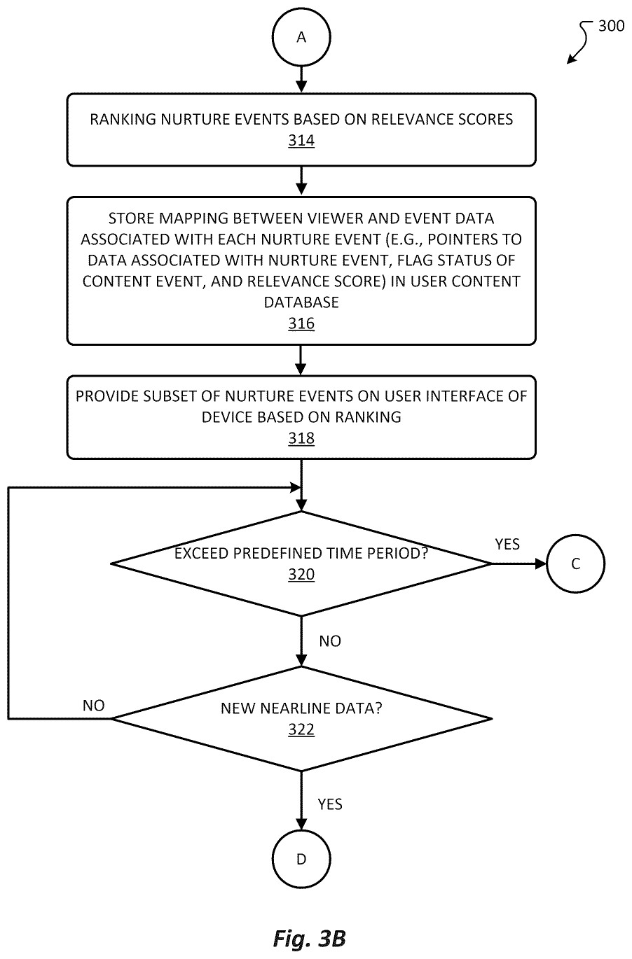

Referring now to FIGS. 3A and 3B, a method 300 for providing relevant nurture events to a viewer of a social network in accordance with examples of the present disclosure is provided. A general order for the steps of the method 300 is shown in FIGS. 3A and 3B. Generally, the method 300 starts at 302 and ends at 324. The method 300 may include more or fewer steps or may arrange the order of the steps differently than those shown in FIGS. 3A and 3B. In the illustrative aspect, the method 300 is performed by a content event manager (e.g., 130) executed on the platform server 160. However, it should be appreciated that one or more steps of the method 300 may be performed by another device (e.g., a server 160).

For example, the platform server 160 may be any suitable computing device that is capable of communicating with the computing device 120. For example, the computing device 120 may be, but is not limited to, a computer, a notebook, a laptop, a mobile device, a smartphone, a tablet, a portable device, a wearable device, or any other suitable computing device that is capable of communicating with the platform server 160. The method 300 can be executed as a set of computer-executable instructions executed by a computer system and encoded or stored on a computer readable medium. Further, the method 300 can be performed by gates or circuits associated with a processor, Application Specific Integrated Circuit (ASIC), a field programmable gate array (FPGA), a system on chip (SOC), or other hardware device. Hereinafter, the method 300 shall be explained with reference to the systems, components, modules, software, data structures, user interfaces, etc. described in conjunction with FIG. 1 and FIGS. 12-14.

The method 300 starts at operation 302, where flow may proceed to 304. At operation 304, the content event manager 130 obtains content data indicative of content events associated with one or more viewees in the social network. In the illustrative embodiment, the content events are any activities that are related to the viewees. For example, the types of content events include celebrations, milestones, social hiring, open to work, feeds, messages, or any type of activities or contents related to viewees. For example, the content data includes offline data and/or nearline data associated with one or more content events. The offline data is batch data that is being received at every specified time (e.g., midnight PST everyday) or every predetermined time period (e.g., every 12 hours). The batch data is processed to obtain content data indicative of content events associated with one or more viewees in the social network. For example, the offline data may include content data that are related to birthday and work anniversaries that are associated with specific dates that are approaching. The nearline data is data associated with present activities of the viewees and is being generating and received in near-real time. For example, the nearline data may include content data that are related to social hiring, open to work, feeds, and messages.

At operation 306, the content event manager 130 selects nurture events from the new content events that satisfy a predetermined condition based on the content data. In the illustrative embodiment, the nurture events are a subset of the content events that are associated with activities of viewees that provide noteworthy opportunities for the viewer to start an interaction with the viewees. For example, the nurture events are particular types of content events. The content event manager 130 selects nurture events that satisfy particular types of content events. For example, the nurture events may include birthdays, job changes, work anniversaries, promotions, trending content, education completion, mentioned in news, social hiring, open to work, feeds, messages, or any noteworthy activities or contents related to a viewee.

For example, types of nurture events are predefined by the social network platform. Additionally or alternatively, the viewer may select the types of nurture events that the viewer considers noteworthy to start an interaction with the viewees. Additionally or alternatively, the content event manager 130 may determine the types of nurture events specific to the viewer using one or more machine learning models. For example, the one or more machine learning models are trained to determine one or more types of nurture events that a particular viewer is more likely to engage or consider as noteworthy opportunities to reach out to the viewees based on user data, as indicated in operation 308. For example, the user data includes personal information (e.g., personal and professional background, educations, work experiences, values, hobbies, affiliations, etc.) of the viewer on the social network and/or any data of the viewer indicative of various activities of the viewer on the social network. The user data indicates an objective (e.g., job-to-be-done) of the viewer, which represents what the viewer is trying to achieve or accomplish by engaging or being active on the social network. For example, the user objective may be finding a new career, nurturing more meaningful connections in a particular industry, or helping others in the social network. In some embodiments, the content event manager 130 may predict the viewer objective using one or more machine learning model.

At operation 310, the content event manager 130 obtains engagement data associated with the viewer. The engagement data indicates interactions between the viewer and content generated by one or more members of the social network, and the content is distributed on multiple platforms (also referred to as surfaces) associated with the social network. For example, the platform includes any platform that the viewer is a user or member of and may be connected to the social network platform. For example, the platforms include email, feed, and other environments that drive user engagement.

For example, the engagement data indicates one or more engagement metrics of the viewer. For example, the one or more engagement metrics include a number of clicks, click through rates (CTR), engagement times, shares, comments, reactions, or any other metrics that represent activities of the viewer on the social network.

For example, according to some embodiments, the engagement data includes a connection feature, a notification affinity feature, and/or a feed affinity feature. The connection feature indicates connection strength between the viewer and one or more members of the social network. The notification affinity feature indicates interactions between the viewer and one or more notifications generated by a respective member of the one or more members of the social network during a predefined time period (e.g., last 90 days). In other words, the notification affinity between the viewer and a member of the one or more members corresponds to a number of clicks that the viewer engaged with one or more notifications related to the respective member. The feed affinity feature indicates interactions between the viewer and one or more feeds generated by a respective member of the one or more members of the social network during a predefined time period (e.g., last 180 days). In other words, the feed affinity between the viewer and a member of the one or more members corresponds to a number of clicks that the viewer engaged with one or more feeds related to the respective member.

According to some embodiments, the engagement data may also include other affinity features that represent activities or engagement of the viewer on different platforms or applications (e.g., one or more different platforms associated with the social network platform). The content event manager 130 extracts one or more additional affinity features between with the viewer and the viewees.

At operation 312, the content event manager 130 determines a relevance score for each nurture event using a relevance model based on the engagement data and one or more attributes associated with the corresponding nurture event. The relevance score represents a likelihood of viewer to engage with the corresponding nurture event. The relevance model is one or more machine learning models, including a large language model (LLM), a deep neural network model, a regression model, other type of machine learning models, or a combination of models.

For example, the one or more attributes associated with a nurture event includes a type of the corresponding nurture event, an age of the corresponding nurture event, a time-sensitivity of the corresponding nurture event, and any other factors that indicate importance or timeliness of the corresponding nurture event.

For example, according to some embodiments, the content event manager 130 normalizes the engagement data, including the connection feature, the notification affinity feature, and the feed affinity feature, and combines the normalized features using some initial weights to determine a relevance score between the viewer and the corresponding viewee. The content event manager 130 adjusts the relevance score of a nurture event by accounting the one or more attributes associated with the corresponding nurture event. For example, the relevance score is discounted (e.g., exponential decay) based on the age of the corresponding nurture event.

In other example, if the corresponding nurture event is a time-sensitive nurture event, the relevance score is adjusted based on the actual date associated with the corresponding nurture content event. For example, the relevance score of a time-sensitive nurture event increases as the proximity to an approaching nurture event date decreases. In other words, time-sensitive nurture events, such as birthdays, are scored higher when it is closer to the actual date of the corresponding nurture event.

According to some embodiments, affinity scores between the viewer and the viewees may also be considered in determining the relevance score for each nurture event using the relevance model. To do so, the content event manager 130 analyzes the engagement data to determine the affinity scores between the viewer and the viewees. Each affinity score indicates a connection affinity between the viewer and the respective viewee. For example, the affinity score between the viewer and a respective viewee increases as activities between the viewer and the respective viewee increases (e.g., more clicks on notifications or feeds related to the respective viewee). In other words, the more the viewer engages with content related to the respective viewee, the higher the affinity score is. According to certain embodiments, the user objective may also be considered in determining the relevance score for each nurture event using the relevance model.

Subsequent to generating the relevance scores, the method 300 advances to operation 314 in FIG. 3B.

At operation 314, the content event manager 130 ranks the nurture events based on the relevance scores. At operation 316, the content event manager 130 stores a mapping between the viewer and event data associated with each nurture event in a user content database (e.g., 138). For example, the event data includes a pointer to the content data associated with the corresponding nurture event, a flag status of the corresponding nurture event, a relevance score of the corresponding nurture event, and a ranking of the corresponding nurture event.

At operation 318, the content event manager 130 provides a subset of the nurture events to the viewer on a user interface of a device (e.g., 120) based on the ranking. For example, the content event manager 130 identifies the subset of the nurture events that exceeds a predetermined relevance threshold. In other example, the content event manager 130 selects a predefined number of nurture events (e.g., top three nurture events) that have the highest ranking. Specifically, the subset of the nurture events is presented under a nurture tab of the social network assigned for nurturing relationships.

According to some embodiments, prior to providing the subset of nurture events on the user interface, the content event manager 130 further determines whether any of the subset of nurture events should be badged for notifying the viewer. For example, for each nurture event, the content event manager 130 may determine whether the corresponding nurture event satisfies a predefined badging condition and/or a predefined relevance condition.

The predefined badging condition defines whether a particular type of nurture events should be notified to the viewer. For example, the predefined badging condition is whether the type of the corresponding nurture event is at least one of the predefined types of content event. According to some embodiments, the viewer can indicate what types of nurture events that the viewer wants to be notified of. For example, the viewer can turn on or off a badging setting of a particular type of nurture events. In other words, a nurture event that has the badging setting turned off is deemed not interested by the viewer and, thus, is not notified to the viewer.

The predefined relevance condition defines whether each nurture event is deemed highly relevant to the viewer's user experience. For example, the predefined relevance condition is whether the relevance score of the corresponding nurture event exceeds a predefined relevance score threshold (e.g., whether the nurture event should be badged for notifying the viewer). In other words, for each nurture event, the content event manager 130 determines whether the relevance score of the corresponding nurture event exceeds the predefined relevance score threshold. It should be appreciated that the relevance score threshold may be predefined by the social network platform, defined by the viewer, and/or determined using one or more machine learning models. In some embodiments, the viewer may further define a type of nurture event and filter the nurture events that exceeds the predefined relevance threshold.

It should be appreciated that the content event manager 130 automatically and continually update the subset of the nurture events to be presented on the nurture page. To do so, at operation 320, the content event manager 130 determines if a predefined time period has been exceeded since presenting the subset of the nurture events. If the predefined time period has been exceeded, the method 300 loops back to the operation 304 to continue obtaining subsequent content data to update a list of the one or more nurture events associated with the viewees.

If, however, the content event manager 130 determines that the predefined time period has not been exceeded since presenting the subset of the nurture events, the method 300 advances to operation 322. At the operation 322, the content event manager 130 determines if new nearline data has been obtained, received, or otherwise detected. If not, the method 300 loops back to the operation 320 to continue determining if the predefined time period has been exceeded.

If, however, the content event manager 130 determines that new nearline data has been obtained, received, or otherwise detected, the method 300 loops back to the operation 310 to continue obtaining subsequent engagement data associated with the viewer.

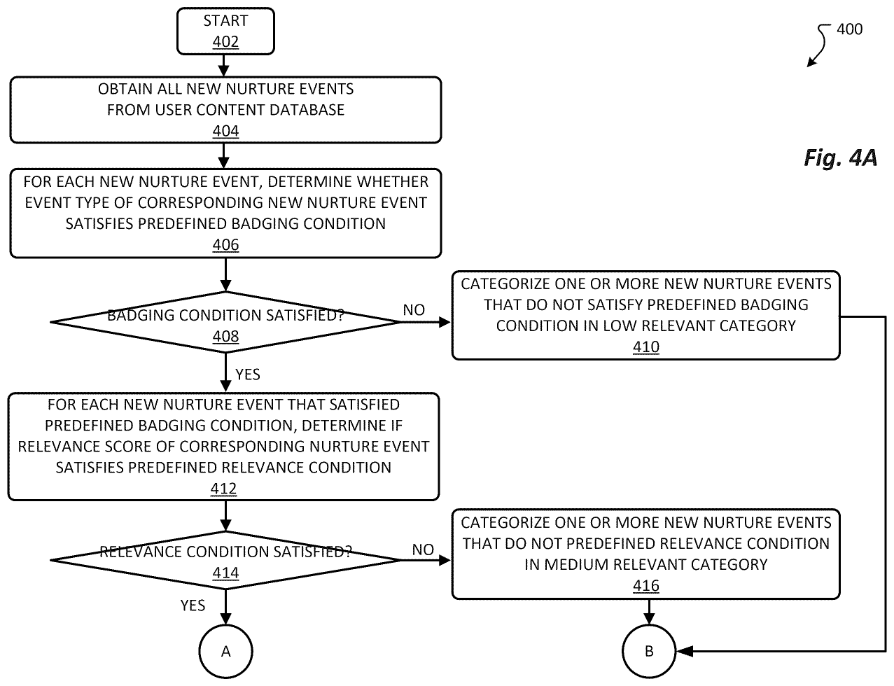

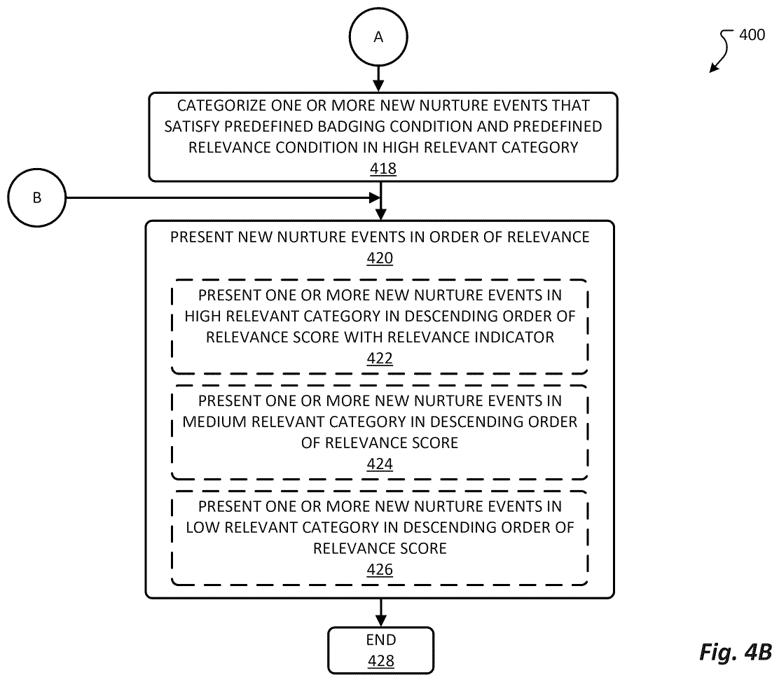

Referring now to FIGS. 4A and 4B, a method 400 for presenting new relevant nurture events on a nurture page of a social network in accordance with examples of the present disclosure is provided. A general order for the steps of the method 400 is shown in FIGS. 4A and 4B. Generally, the method 400 starts at 402 and ends at 428. The method 400 may include more or fewer steps or may arrange the order of the steps differently than those shown in FIGS. 4A and 4B. In the illustrative aspect, the method 400 is performed by a content event manager (e.g., 130) executed on the platform server 160. However, it should be appreciated that one or more steps of the method 400 may be performed by another device (e.g., a server 160).

Specifically, in some aspects, the method 400 may be performed by a content event manager (e.g., 130) executed on the platform server 160. For example, the platform server 160 may be any suitable computing device that is capable of communicating with the computing device 120. For example, the computing device 120 may be, but is not limited to, a computer, a notebook, a laptop, a mobile device, a smartphone, a tablet, a portable device, a wearable device, or any other suitable computing device that is capable of communicating with the platform server 160. The method 400 can be executed as a set of computer-executable instructions executed by a computer system and encoded or stored on a computer readable medium. Further, the method 400 can be performed by gates or circuits associated with a processor, Application Specific Integrated Circuit (ASIC), a field programmable gate array (FPGA), a system on chip (SOC), or other hardware device. Hereinafter, the method 400 shall be explained with reference to the systems, components, modules, software, data structures, user interfaces, etc. described in conjunction with FIG. 1 and FIGS. 12-14.

The method 400 starts at operation 402, where flow may proceed to 404. At operation 404, the content event manager 130 obtains all nurture events that are new from a user content database (e.g., 138) associated with a viewer of the social network. According to some embodiments, the content event manager 130 determines a unique user identifier that is assigned to the viewer on the social network and obtains all the new nurture events associated with the viewer based on the user identifier from the user content database.

As described above, the nurture events are particular types of content events associated with one or more viewees in the social network that are designed to cultivate relationships between the viewer and the one or more viewees. For example, the nurture events are activities of viewees that provide noteworthy opportunities for the viewer to start an interaction with the viewees. The types of content events may be predefined by the social network platform, defined by the viewer, and/or determined using one or more machine learning models. For example, the one or more machine learning models are trained to determine one or more types of content events that a particular viewer is more likely to engage or consider as noteworthy opportunities to reach out to the viewees based on user data. The user data may include personal information (e.g., personal and professional background, educations, work experiences, values, hobbies, affiliations, etc.) of the viewer on the social network and/or any data of the viewer indicative of various activities of the viewer on the social network.

Additionally, each nurture event has a status flag that indicates whether the nurture event has been presented to the viewer. For example, the status flag is set to a first flag if the corresponding nurture event has not previously presented to or seen by the viewer (i.e., “new” content event) and is set to a second flag if the corresponding nurture event has been presented, seen, or otherwise read by the viewer.

At operation 406, for each new nurture event, the content event manager 130 determines whether the event type of the corresponding new nurture event satisfies a predefined badging condition. The predefined badging condition defines whether a particular type of nurture events should be notified to the viewer. For example, the predefined badging condition is whether the type of the corresponding new nurture event is at least one of the predefined types of content event. According to some embodiments, the viewer can indicate what types of nurture events that the viewer wants to be notified of. For example, the viewer can turn on or off a badging setting of a particular type of nurture events. In other words, a new nurture event that has the badging setting turned off is deemed not interested by the viewer and, thus, is not notified to the viewer. However, it should be appreciated that such new nurture event is still presented on the nurture page for the viewer.

If the content event manager 130 determines that at least one new nurture event does not satisfy the predefined badging condition in operation 408, the method 400 proceeds to operation 410. At the operation 410, the content event manager 130 categorizes one or more new nurture events that do not satisfy the predefined badging condition in a low relevant category. The method 400 then advances to operation 420 to present the one or more new nurture events in the low relevant category on the nurture page, as described further below.

If, however, the content event manager 130 determines that at least one new nurture event does satisfy the predefined badging condition in operation 408, the method 400 advances to operation 412.

At operation 412, the content event manager 130 further determines if a relevance score of each nurture event satisfies a predefined relevance condition. The predefined relevance condition defines whether each new nurture event is deemed highly relevant to the viewer's user experience. For example, the predefined relevance condition is whether the relevance score of the corresponding new nurture event exceeds a predefined relevance score threshold (e.g., whether the new nurture event should be badged for notifying the viewer). In other words, for each new nurture event, the content event manager 130 determines whether the relevance score of the corresponding new nurture event exceeds the predefined relevance score threshold. It should be appreciated that the relevance score threshold may be predefined by the social network platform, defined by the viewer, and/or determined using one or more machine learning models. In some embodiments, the viewer may further define a type of nurture event and filter the new nurture events that exceeds the predefined relevance threshold.

If the content event manager 130 determines that one or more new nurture events do not satisfy the predefined relevance condition at operation 414, the method 400 proceeds to operation 416. At the operation 416, the content event manager 130 categorizes one or more new nurture events that do not satisfy the predefined relevance condition in a medium relevant category. The method 400 then advances to operation 420 to present the one or more new nurture events in the medium relevant category on the nurture page, as described further below.

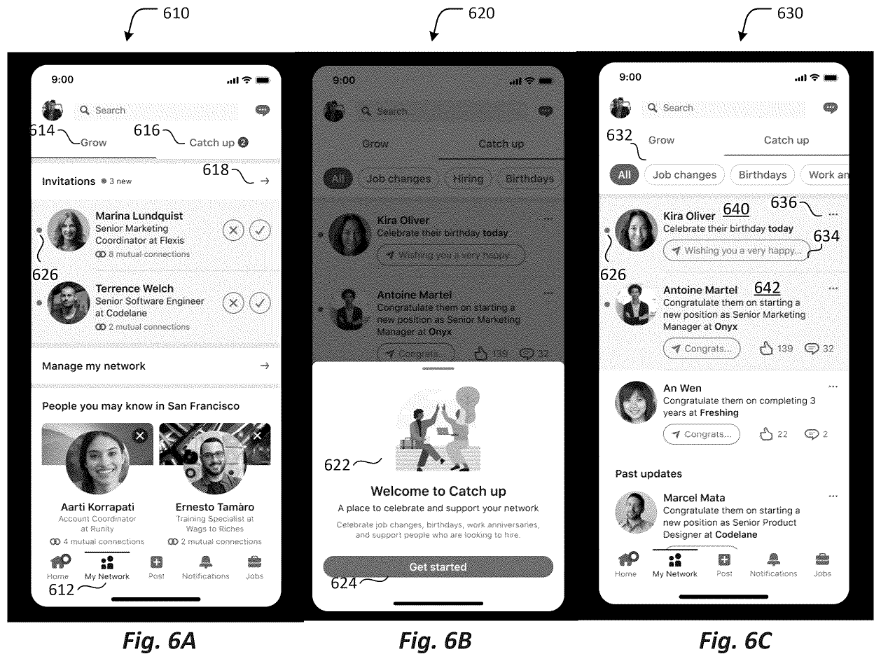

If, however, the content event manager 130 determines that one or more new nurture events satisfy the predefined relevance condition at operation 414, the method 400 proceeds to operation 418 in FIG. 4B. At the operation 418, the content event manager 130 categorizes one or more new nurture events that satisfy the predefined relevance condition in a high relevant category. Subsequently, the method 400 then advances to operation 420 to present the new nurture events to the viewer in the order of relevance. To do so, at operation 422, in response to determining that one or more new nurture events are in the high relevant category, the content event manager 130 presents the one or more new nurture events from the high relevant category in a descending order of relevance score. It should be appreciated that the new nurture events that are considered high relevance are presented with a relevance indicator on the nurture page. For example, as shown in FIG. 6C, the nurture events that are considered “new” are highlighted, and the new nurture events that are in the high relevant category are marked with a dot. Such indicators allow the viewer to easily identify the new nurture events that are considered to be highly relevant to the viewer.

In the illustrative embodiment, a number of new nurture events from the high relevant category that are marked with a relevance indicator is limited to a predefined number. For example, if the predefined number is three, top three new nurture events that have the highest relevance scores from all the new nurture events in the high relevant category are marked with a relevance indicator on the nurture page at most. In other words, while all the new nurture events from the high relevant category are shown on the nurture page, only a subset of those new nurture events are marked with a relevant indicator and included in a badge count. As described further below, the nurture page is badged with a number of new nurture events that are in the highly relevant category.

At operation 424, in response to determining that one or more new nurture events are in the medium relevant category, the content event manager 130 presents the one or more new nurture events from the medium relevant category in a descending order of relevance score. At operation 426, in response to determining that one or more new nurture events are in the low relevant category, the content event manager 130 presents the one or more new nurture events from the low relevant category in a descending order of relevance score. It should be appreciated that while all the nurture events are “new” are highlighted, those new nurture events that correspond to medium and low relevance are not presented with a relevance indicator. Subsequently, the method 400 may end at 428.

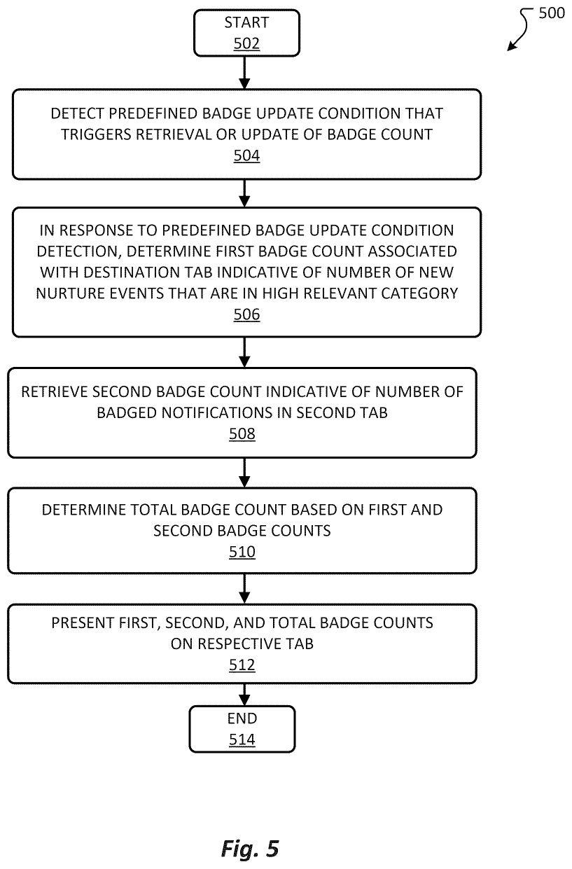

Referring now to FIG. 5, a method 500 for presenting a badge count to a viewer of a social network in accordance with examples of the present disclosure is provided. A general order for the steps of the method 500 is shown in FIG. 5. Generally, the method 500 starts at 502 and ends at 514. The method 500 may include more or fewer steps or may arrange the order of the steps differently than those shown in FIG. 5. In the illustrative aspect, the method 500 is performed by a content event manager (e.g., 130) executed on the platform server 160. However, it should be appreciated that one or more steps of the method 500 may be performed by another device (e.g., a server 160).

For example, the platform server 160 may be any suitable computing device that is capable of communicating with the computing device 120. For example, the computing device 120 may be, but is not limited to, a computer, a notebook, a laptop, a mobile device, a smartphone, a tablet, a portable device, a wearable device, or any other suitable computing device that is capable of communicating with the platform server 160. The method 500 can be executed as a set of computer-executable instructions executed by a computer system and encoded or stored on a computer readable medium. Further, the method 500 can be performed by gates or circuits associated with a processor, Application Specific Integrated Circuit (ASIC), a field programmable gate array (FPGA), a system on chip (SOC), or other hardware device. Hereinafter, the method 500 shall be explained with reference to the systems, components, modules, software, data structures, user interfaces, etc. described in conjunction with FIG. 1 and FIGS. 12-14.

The method 500 starts at operation 502, where flow may proceed to 504. At operation 504, the content event manager 130 detects a predefined badge update condition that triggers retrieval of new nurture events and/or update of a badge count. For example, detecting the predefined badge update condition includes receiving an indication that a viewer has logged into the social network via a social network app or a social network website, receiving an indication that the viewer has opened or reopened the social network app where the viewer is already logged in, and/or detecting a predefined time period has passed since the last badge update.

In response to detecting the predefined badge condition at operation 506, the content event manager 130 determines a first badge count associated with a nurture tab. The first badge count represents a number of new nurture events that are in a high relevant category. As described above in FIGS. 4A and 4B, the new nurture events that are in the high relevant category include the nurture events that have a status flag set to a first flag (e.g., previously have not been presented, seen, or read by the viewer) and satisfy the badging condition and the relevance condition.

The predefined badging condition defines whether a particular type of nurture events should be notified to the viewer. For example, the predefined badging condition is whether the type of the corresponding new nurture event is at least one of the predefined types of content event. According to some embodiments, the viewer can indicate what types of nurture events that the viewer wants to be notified of. For example, the viewer can turn on or off a badging setting of a particular type of nurture events. In other words, a new nurture event that has the badging setting turned off is deemed not interested by the viewer and, thus, is not notified to the viewer. However, it should be appreciated that such new nurture event is still presented on the nurture page for the viewer. The predefined relevance condition defines whether each new nurture event is deemed highly relevant to the viewer's user experience. For example, the predefined relevance condition includes whether the relevance score of the corresponding new nurture event exceeds a predefined relevance score threshold (e.g., whether the new nurture event should be badged for notifying the viewer). It should be appreciated that the relevance score threshold may be predefined by the social network platform, defined by the viewer, and/or determined using one or more machine learning models. In some embodiments, the first badge count is stored in a user content database (e.g., 138).

At operation 508, the content event manager 130 retrieves a second badge count indicative of a number of badged notifications in a second tab. The second badge count is associated with a second tab and represents a number of new invitations that have been received. For example, the invitation may be an invitation from another user of the social network requesting to connect, an invitation to follow a page and/or an invitation to subscribe to a newsletter. Additionally, the second badge count may also include a number of new messages that have not been presented to the viewer.

At operation 510, the content event manager 130 determines a total badge count based on the first and second badge counts. For example, the content event manager 130 combines the first badge count and the second badge count to determine the total badge count.

At operation 512, the content event manager 130 presents first, second, and total badge counts on respective tabs. According to some embodiments, the viewer can access “My Network” tab to manage (e.g., add, remove, sort, search, and/or message) the viewer's network within the social network. As illustrated in FIGS. 6A-6C, My Network tab includes two sub-tabs, “Grow” tab and “Catch up” tab. Each sub-tab is badged. For example, the Grow tab is the second tab that is badged with the second badge count, and the Catch up tab is the nurture tab that is badged with the first badge count. The total badge count is shown on My Network tab. In such embodiments, Grow tab focuses on growing connections in the social network, while the nurture tab focuses on nurturing connections in the viewer's network within the social network.

Referring now to FIGS. 6-10, exemplary screenshots of a user interface of a social network app on a mobile device of a viewer in accordance with examples of the present disclosure are provided.

As shown in FIG. 6A, an exemplary user interface 610 is presented to a viewer when the viewer clicks on My Network tab 612. My Network tab is further divided into Grow tab 614 and Catch up tab 616. Grow tab 614 focuses on growing connections in the social network, and the Catch up tab 616 focuses on nurturing connections in the viewer's network within the social network. In the illustrative embodiment, when the viewer clicks on My Network tab 612, it automatically takes the viewer to Grow tab 614. However, it should be appreciated that, in some embodiments, My Network tab 612 can open the tab 614, 616 that the viewer accessed the last time.

Under Grow tab 614, new invitations that have been received are presented to the viewer. In this case, the invitations are from other users of the social network requesting to connect. For example, as shown in FIG. 6A, the viewer has received three new invitations but only two new invitations that are badged are shown on the page. The viewer can click on the arrow icon 618 to access all the new invitations. In the illustrative embodiment, the new invitations are highlighted, and the new invitations that are badged are presented with a dot indicator 626. It should be appreciated that each of My Network tab 612, Grow tab 614, and Catch up tab 616 has its own corresponding badge. A badge count for My Network tab 612 is a combination of a badge count for Grow tab 614 and a badge count for Catch up tab 616. Additionally, the viewer can also manage my network and see people who the viewer may know under Grow tab 614.

As shown in FIG. 6B, an exemplary user interface 620 is presented to the viewer when the viewer taps Catch up tab 616 for the first time. The user interface 620 includes a “Welcome to Catch up” message 622 that pops up explaining that Catch up tab 616 is “A place to celebrate and support your network.” Once the viewer taps “Get Started” icon 624, the viewer can access Catch up tab 616, as shown in FIG. 6C.

As shown in FIG. 6C, an exemplary user interface 630 is presented to the viewer when the viewer taps Get Started icon 624 or subsequently taps Catch up tab 616. Under Catch up tab 616, a list of nurture events related to connections (“viewee”) that are most relevant to the user is presented to the viewer. As described above, to identify the relevant nurture events, a machine learning model is used to determine which nurture events are more relevant to the viewer by ranking the nurture events based on user engagement data (e.g., connection strength, notification affinity, and/or feed affinity) and one or more attributes associated with the corresponding nurture event (e.g., a type of nurture event). For example, the nurture events include celebrations (e.g., birthdays, job changes, work anniversaries), milestones (e.g., promotions), and social hiring. In other words, the viewer is presented with the relevant “noteworthy” nurture events that are related to those viewees in the network that the viewer is more likely to engage with. The viewer can also filter the nurture events by selecting the type of nurture events (e.g., Job changes, Birthdays, Work anniversaries) from a menu bar 632.

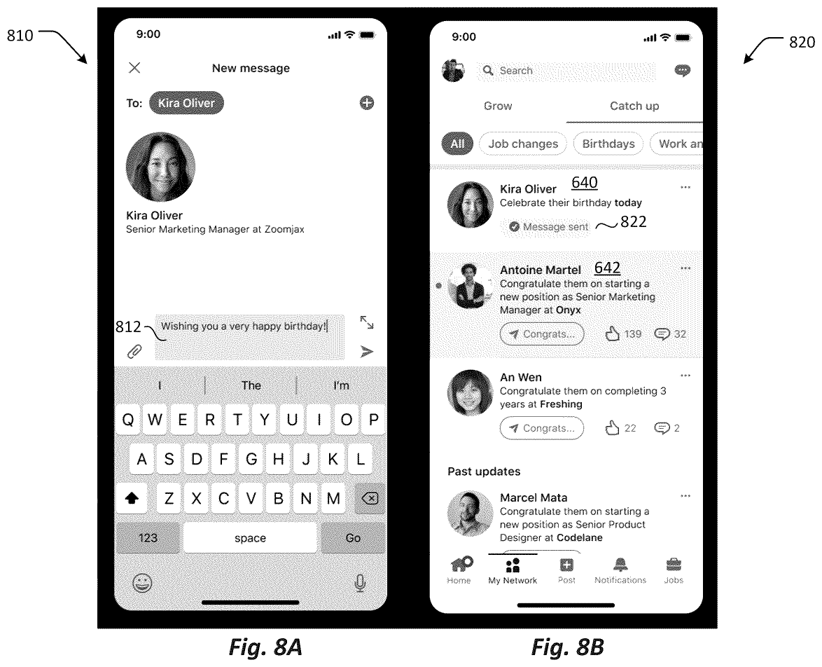

In the illustrative embodiment, the new nurture events are highlighted, and the new invitations that are badged are presented with a dot indicator 626. Once the new nurture event is presented to the viewer under the Catch up tab 616, the corresponding new nurture event is no longer highlighted and the dot indicator 626 is removed. Additionally, the viewer can directly send a message to the corresponding viewee directly from Catch up tab 616. For example, if the viewer clicks on the button 634 associated with the nurture event 640, New message pop-up window 810 appears as shown in FIG. 8A to allow the viewer to send a message to the corresponding viewee. In the illustrative embodiment, the pre-generated message (e.g., “Wishing you a very happy birthday!”) is automatically presented in a message box 812 to the viewer, and the viewer can send the message as is or choose to edit the message before sending it to the viewee.

Once the message is sent, the New Message pop-up window 810 disappears and the viewer is automatically taken back to Catch up tab 616, as shown in the user interface 820 in FIG. 8B. Additionally, a status indicator 822 appears on the corresponding nurture event to indicate that the message has been sent. It should be noted that the nurture event 640 is no longer highlighted and the dot indicator 626 has been removed. However, the nurture event 642 is still highlighted and has a dot indicator 626 since the viewer has not left Catch up tab 616 since the new nurture event 642 was first presented to the viewer. If the viewer leaves current Catch up tab 616 (e.g., by closing or leaving the social network app on the viewer's mobile device, or by clicking other tabs, such as Home, Post, Notifications, or Jobs) and recesses the Catch up tab 616, the nurture event 642 will not be considered “new” and therefore no longer be highlighted or indicated with a dot indicator 626.

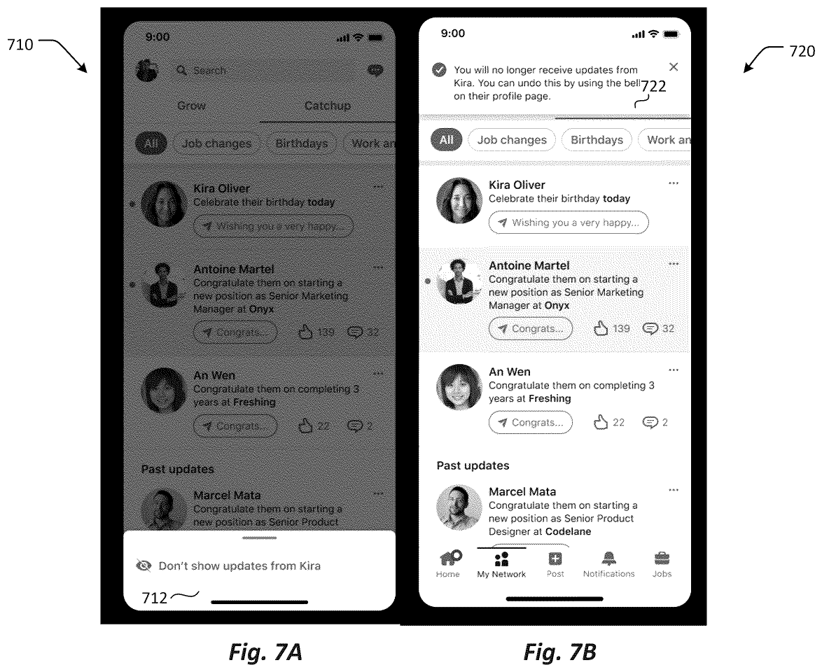

Referring back to FIG. 6C, if the viewer clicks on a three-dot menu 636 associated with the nurture event 640, the viewer has an option to remove the corresponding viewee from the update. For example, if the viewer clicks on the three-dot menu 636, a pop-up menu 712 appears indicating whether the viewer wishes not to show updates from the corresponding viewee, as shown in an exemplary user interface 710 of FIG. 7A. If the viewer selects not to show updates from the corresponding viewee, a notification 722 appears indicating that the viewer will no longer receive updates from the corresponding viewee, as shown in an exemplary user interface 720 of FIG. 7B. The notification 722 also includes how to enable the update from the corresponding viewee again (e.g., by using the bell on the corresponding viewee's profile page).

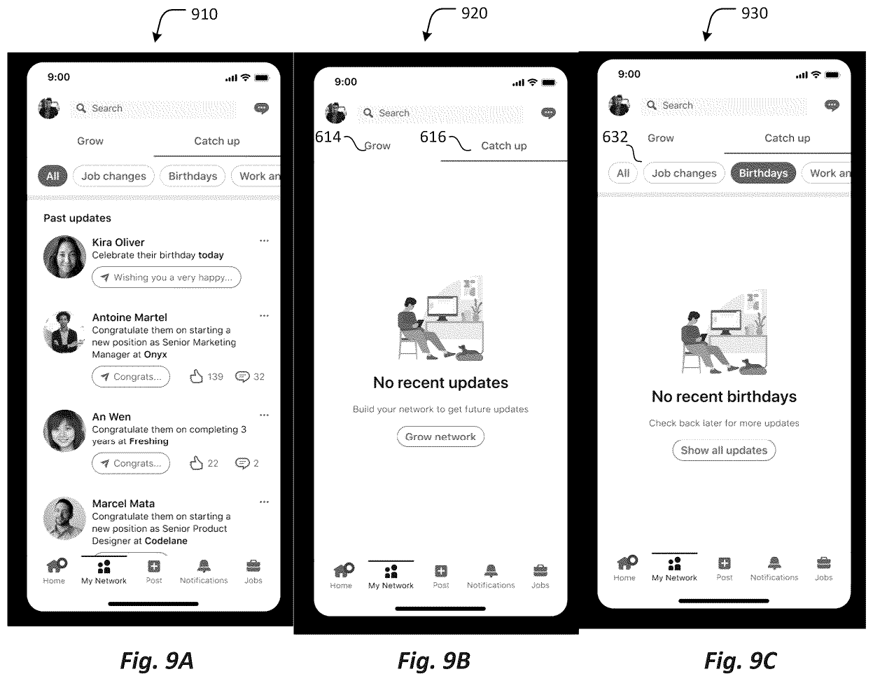

Referring now to FIG. 9A, an exemplary user interface 910 illustrates when there are no new nurture events to present to the viewer under Catch up tab 616. In such a case, the viewer is notified that there are no recent updates and given an option to grow network, which will take the viewer to Grow tab 614.

Referring now to FIG. 9A, an exemplary user interface 910 illustrates when there are no new nurture events to present to the viewer under Catch up tab 616. In such a case, the viewer is presented with past nurture events (e.g., past updates). In the illustrative embodiment, the past nurture events are kept for 90 days. However, it should be appreciated that the expiry time period for past nurture events may be different depending on the type of the nurture events.

Referring now to FIG. 9B, an exemplary user interface 920 illustrates when there are no new nurture events to present to the viewer under Catch up tab 616 and all past nurture events have been expired. In such a case, the viewer is notified that there are no recent updates and given an option to grow network, which will take the viewer to Grow tab 614.

Referring now to FIG. 9C, an exemplary user interface 930 illustrates when there are no selected type of nurture events to present to the viewer under Catch up tab 616. As described above, the viewer can filter the nurture events from the menu bar 632. If the viewer selects Birthdays and there are no new Birthday nurture events, the viewer is notified that there are no recent birthdays and given an option to show all updates.

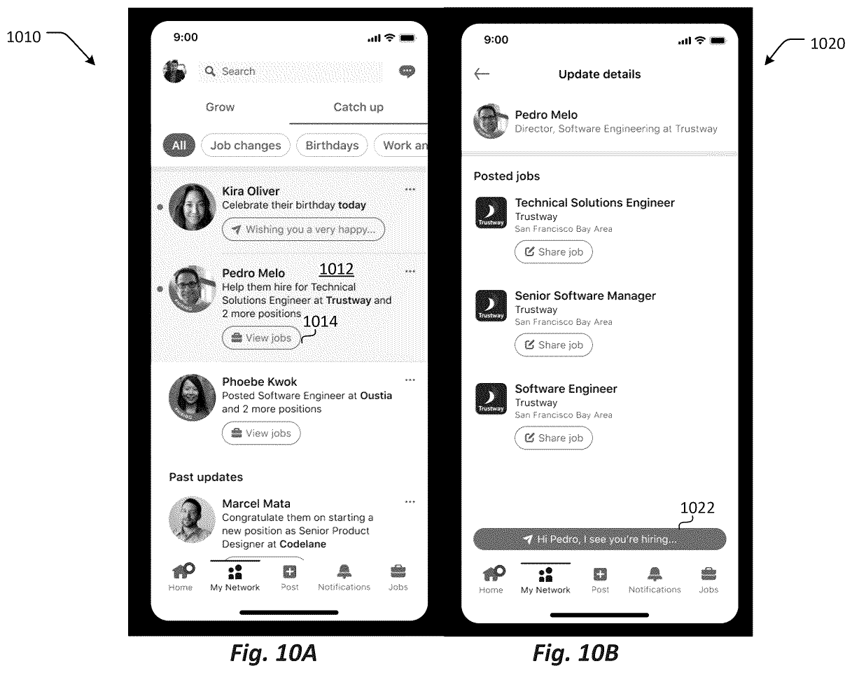

Referring now to FIG. 10A, an exemplary user interface 1010 illustrates that when there are multiple nurture events of the same type related to the same viewee, those nurture events are aggregated into a single nurture event card 1012. If the viewer clicks on View Jobs button 1014, a list of posted jobs related to the corresponding viewee is presented to the viewer as shown in a user interface 1029 of FIG. 10B. The viewer can directly message the corresponding viewee by clicking a message button 1022 with a pre-generated message (e.g., “Hi Pedro, I see you're hiring . . . ”). When the viewer clicks on the message button 1022, New message pop-up window, similar to the pop-up window 810 shown in FIG. 8A, appears to allow the viewer to send a message to the corresponding viewee. In the illustrative embodiment, the pre-generated message (e.g., “Hi Pedro, I see you're hiring. I would like to discuss this opportunity further at your convenience.”) is automatically presented in a message box to the viewer, and the viewer can send the message as is or choose to edit the message before sending it to the viewee.

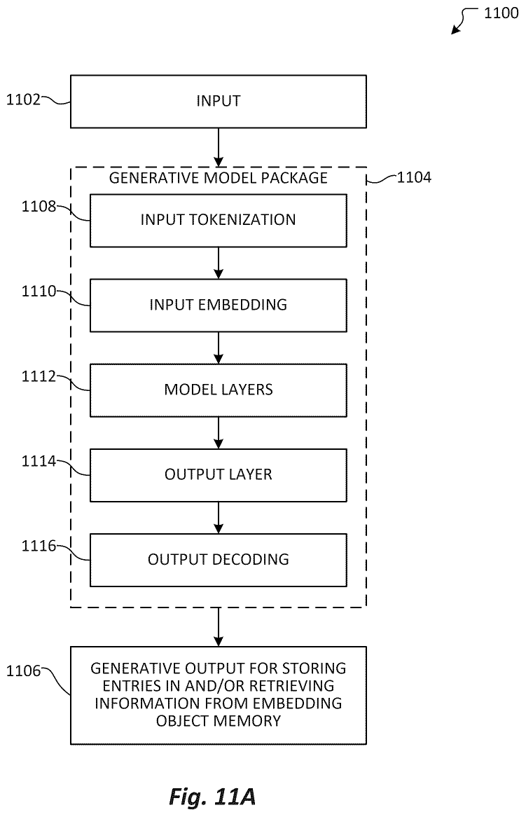

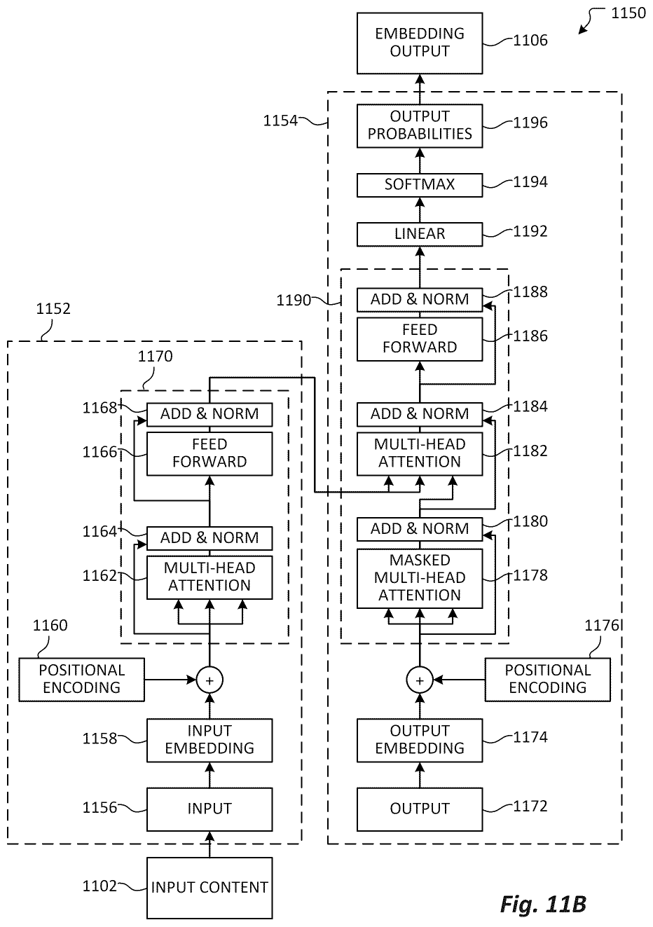

FIGS. 11A and 11B illustrate overviews of an example generative machine learning model that may be used according to aspects described herein. With reference first to FIG. 11A, conceptual diagram 1100 depicts an overview of pre-trained generative model package 1104 that processes an input 1102 to generate model output for storing entries in and/or retrieving information from a generative model output 1106 (e.g., suggestions and/or suggested modifications) according to aspects described herein.

In examples, generative model package 1104 is pre-trained according to a variety of inputs (e.g., a variety of human languages, a variety of programming languages, and/or a variety of content types) and therefore need not be finetuned or trained for a specific scenario. Rather, generative model package 1104 may be more generally pre-trained, such that input 1102 includes a prompt that is generated, selected, or otherwise engineered to induce generative model package 1104 to produce certain generative model output 1106. It will be appreciated that input 1102 and generative model output 1106 may each include any of a variety of content types, including, but not limited to, text output, image output, audio output, video output, programmatic output, and/or binary output, among other examples. In examples, input 1102 and generative model output 1106 may have different content types, as may be the case when generative model package 1104 includes a generative multimodal machine learning model.

As such, generative model package 1104 may be used in any of a variety of scenarios and, further, a different generative model package may be used in place of generative model package 1104 without substantially modifying other associated aspects (e.g., similar to those described herein with respect to FIGS. 1-5). Accordingly, generative model package 1104 operates as a tool with which machine learning processing is performed, in which certain inputs 1102 to generative model package 1104 are programmatically generated or otherwise determined, thereby causing generative model package 1104 to produce model output 1106 that may subsequently be used for further processing.

Generative model package 1104 may be provided or otherwise used according to any of a variety of paradigms. For example, generative model package 1104 may be used local to a computing device (e.g., the computing device 120 in FIG. 2) or may be accessed remotely from a machine learning service (e.g., the server 160 in FIG. 2). In other examples, aspects of generative model package 1104 are distributed across multiple computing devices. In some instances, generative model package 1104 is accessible via an application programming interface (API), as may be provided by an operating system of the computing device and/or by the machine learning service, among other examples.

With reference now to the illustrated aspects of generative model package 1104, generative model package 1104 includes input tokenization 1108, input embedding 1110, model layers 1112, output layer 1114, and output decoding 1116. In examples, input tokenization 1108 processes input 1102 to generate input embedding 1110, which includes a sequence of symbol representations that corresponds to input 1102. Accordingly, input embedding 1110 is processed by model layers 1112, output layer 1114, and output decoding 1116 to produce model output 1106. An example architecture corresponding to generative model package 1104 is depicted in FIG. 11B, which is discussed below in further detail. Even so, it will be appreciated that the architectures that are illustrated and described herein are not to be taken in a limiting sense and, in other examples, any of a variety of other architectures may be used.

FIG. 11B is a conceptual diagram that depicts an example architecture 1150 of a pre-trained generative machine learning model that may be used according to aspects described herein. As noted above, any of a variety of alternative architectures and corresponding ML models may be used in other examples without departing from the aspects described herein.

As illustrated, architecture 1150 processes input 1102 to produce generative model output 1106, aspects of which were discussed above with respect to FIG. 11A. Architecture 1150 is depicted as a transformer model that includes encoder 1152 and decoder 1154. Encoder 1152 processes input embedding 1158 (aspects of which may be similar to input embedding 1110 in FIG. 11A), which includes a sequence of symbol representations that corresponds to input 1156. In examples, input 1156 includes content data 1102 corresponding to a content item.

Further, positional encoding 1160 may introduce information about the relative and/or absolute position for tokens of input embedding 1158. Similarly, output embedding 1174 includes a sequence of symbol representations that correspond to output 1172, while positional encoding 1176 may similarly introduce information about the relative and/or absolute position for tokens of output embedding 1174.

As illustrated, encoder 1152 includes example layer 1170. It will be appreciated that any number of such layers may be used, and that the depicted architecture is simplified for illustrative purposes. Example layer 1170 includes two sub-layers: multi-head attention layer 1162 and feed forward layer 1166. In examples, a residual connection is included around each layer 1162, 1166, after which normalization layers 1164 and 1168, respectively, are included.

Decoder 1154 includes example layer 1190. Similar to encoder 1152, any number of such layers may be used in other examples, and the depicted architecture of decoder 1154 is simplified for illustrative purposes. As illustrated, example layer 1190 includes three sub-layers: masked multi-head attention layer 1178, multi-head attention layer 1182, and feed forward layer 1186. Aspects of multi-head attention layer 1182 and feed forward layer 1186 may be similar to those discussed above with respect to multi-head attention layer 1162 and feed forward layer 1166, respectively. Additionally, masked multi-head attention layer 1178 performs multi-head attention over the output of encoder 1152 (e.g., output 1172). In examples, masked multi-head attention layer 1178 prevents positions from attending to subsequent positions. Such masking, combined with offsetting the embeddings (e.g., by one position, as illustrated by multi-head attention layer 1182), may ensure that a prediction for a given position depends on known output for one or more positions that are less than the given position. As illustrated, residual connections are also included around layers 1178, 1182, and 1186, after which normalization layers 1180, 1184, and 1188, respectively, are included.

Multi-head attention layers 1162, 1178, and 1182 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 11B (e.g., by a corresponding normalization layer 1164, 1180, or 1184).

Feed forward layers 1166 and 1186 may each be a fully connected feed-forward network, which applies to each position. In examples, feed forward layers 1166 and 1186 each include a plurality of linear transformations with a rectified linear unit activation in between. In examples, each linear transformation is the same across different positions, while different parameters may be used as compared to other linear transformations of the feed-forward network.

Additionally, aspects of linear transformation 1192 may be similar to the linear transformations discussed above with respect to multi-head attention layers 1162, 1178, and 1182, as well as feed forward layers 1166 and 1186. Softmax 1194 may further convert the output of linear transformation 1192 to predicted next-token probabilities, as indicated by output probabilities 1196. It will be appreciated that the illustrated architecture is provided in as an example and, in other examples, any of a variety of other model architectures may be used in accordance with the disclosed aspects.

Accordingly, output probabilities 1196 may thus form generative model output 1106 according to aspects described herein, such that the output of the generative ML model (e.g., which may include one or more semantic embeddings and one or more retrieved content items) is used as input for determining an action according to aspects described herein. In other examples, generative model output 1106 is provided as generated output for retrieving one or more previously captured content items.

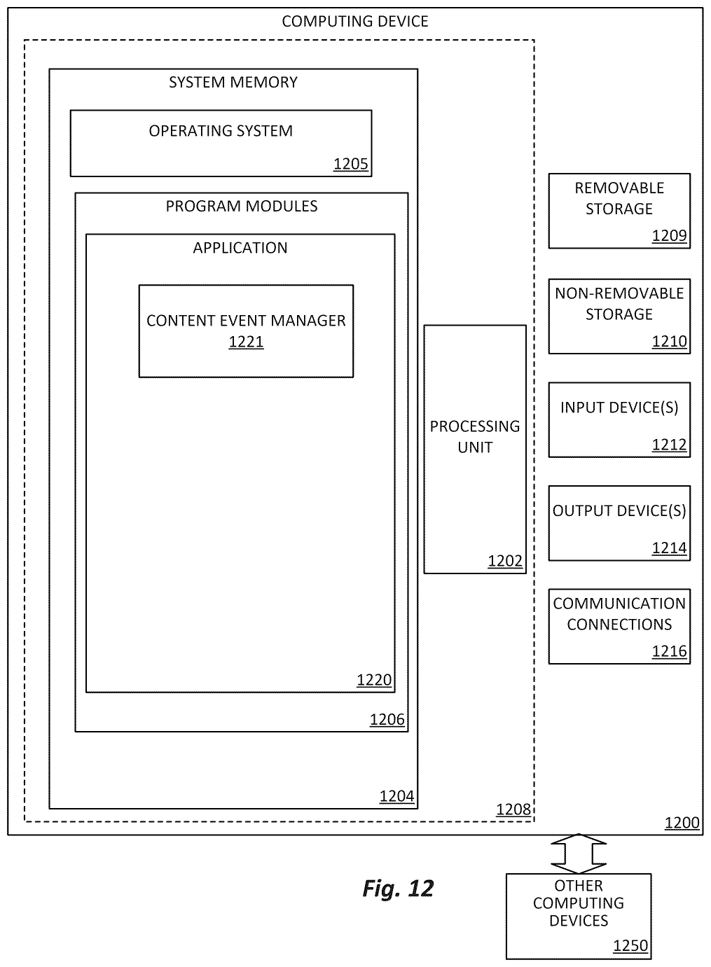

FIGS. 12-14 and the associated descriptions provide a discussion of a variety of operating environments in which aspects of the disclosure may be practiced. However, the devices and systems illustrated and discussed with respect to FIGS. 12-14 are for purposes of example and illustration and are not limiting of a vast number of computing device configurations that may be utilized for practicing aspects of the disclosure, described herein.

FIG. 12 is a block diagram illustrating physical components (e.g., hardware) of a computing device 1200 with which aspects of the disclosure may be practiced. The computing device components described below may be suitable for the computing devices described above, including one or more devices associated with machine learning service (e.g., social network platform server 160), as well as computing device 120 discussed above with respect to FIG. 2. In a basic configuration, the computing device 1200 may include at least one processing unit 1202 and a system memory 1204. Depending on the configuration and type of computing device, the system memory 1204 may comprise, but is not limited to, volatile storage (e.g., random access memory), non-volatile storage (e.g., read-only memory), flash memory, or any combination of such memories.

The system memory 1204 may include an operating system 1205 and one or more program modules 1206 suitable for running software application 1220, such as one or more components supported by the systems described herein. As examples, system memory 1204 may store a content event manager 1221. The operating system 1205, for example, may be suitable for controlling the operation of the computing device 1200.

Furthermore, aspects of the disclosure may be practiced in conjunction with a graphics library, other operating systems, or any other application program and is not limited to any particular application or system. This basic configuration is illustrated in FIG. 12 by those components within a dashed line 1208. The computing device 1200 may have additional features or functionality. For example, the computing device 1200 may also include additional data storage devices (removable and/or non-removable) such as, for example, magnetic disks, optical disks, or tape. Such additional storage is illustrated in FIG. 12 by a removable storage device 1209 and a non-removable storage device 1210.

As stated above, a number of program modules and data files may be stored in the system memory 1204. While executing on the processing unit 1202, the program modules 1206 (e.g., application 1220) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 12 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1200 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 1200 may also have one or more input device(s) 1212 such as a keyboard, a mouse, a pen, a sound or voice input device, a touch or swipe input device, etc. The output device(s) 1214 such as a display, speakers, a printer, etc. may also be included. The aforementioned devices are examples and others may be used. The computing device 1200 may include one or more communication connections 1216 allowing communications with other computing devices 1250. Examples of suitable communication connections 1216 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1204, the removable storage device 1209, and the non-removable storage device 1210 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1200. Any such computer storage media may be part of the computing device 1200. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

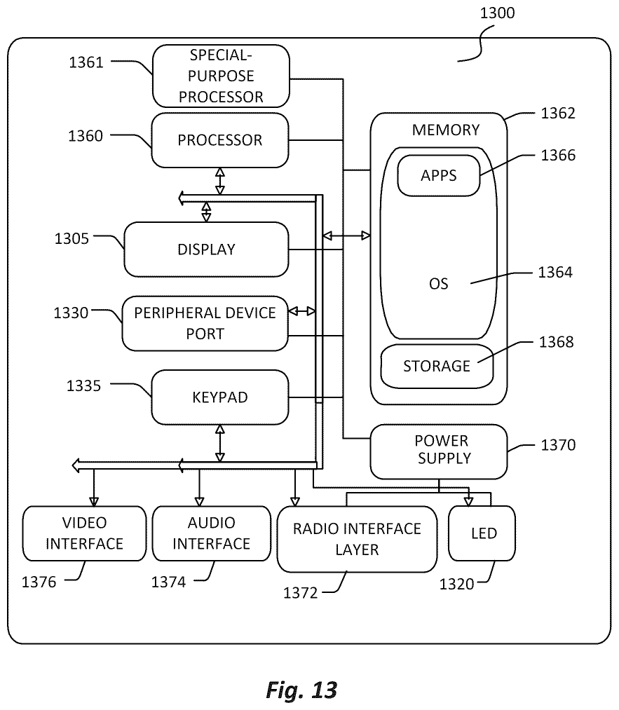

FIG. 13 illustrates a system 1300 that may, for example, be a mobile computing device, such as a mobile telephone, a smart phone, wearable computer (such as a smart watch), a tablet computer, a laptop computer, and the like, with which aspects of the disclosure may be practiced. In one example, the system 1300 is implemented as a “smart phone” capable of running one or more applications (e.g., browser, e-mail, calendaring, contact managers, messaging clients, games, and media clients/players). In some aspects, the system 1300 is integrated as a computing device, such as an integrated personal digital assistant (PDA) and wireless phone.

In a basic configuration, such a mobile computing device is a handheld computer having both input elements and output elements. The system 1300 typically includes a display 1305 and one or more input buttons that allow the user to enter information into the system 1300. The display 1305 may also function as an input device (e.g., a touch screen display).

If included, an optional side input element allows further user input. For example, the side input element may be a rotary switch, a button, or any other type of manual input element. In alternative aspects, system 1300 may incorporate more or less input elements. For example, the display 1305 may not be a touch screen in some aspects. In another example, an optional keypad 1335 may also be included, which may be a physical keypad or a “soft” keypad generated on the touch screen display.

In various aspects, the output elements include the display 1305 for showing a graphical user interface (GUI), a visual indicator (e.g., a light emitting diode 1320), and/or an audio transducer 1325 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 1366 may be loaded into the memory 1362 and run on or in association with the operating system 1364. Examples of the application programs include phone dialer programs, e-mail programs, personal information management (PIM) programs, word processing programs, spreadsheet programs, Internet browser programs, messaging programs, and so forth. The system 1300 also includes a non-volatile storage area 1368 within the memory 1362. The non-volatile storage area 1368 may be used to store persistent information that should not be lost if the system 1300 is powered down. The application programs 1366 may use and store information in the non-volatile storage area 1368, such as e-mail or other messages used by an e-mail application, and the like. A synchronization application (not shown) also resides on the system 1300 and is programmed to interact with a corresponding synchronization application resident on a host computer to keep the information stored in the non-volatile storage area 1368 synchronized with corresponding information stored at the host computer. As should be appreciated, other applications may be loaded into the memory 1362 and run on the system 1300 described herein (e.g., a content capture manager, a content retrieval manager, etc.).

The system 1300 has a power supply 1370, which may be implemented as one or more batteries. The power supply 1370 might further include an external power source, such as an AC adapter or a powered docking cradle that supplements or recharges the batteries.

The system 1300 may also include a radio interface layer 1372 that performs the function of transmitting and receiving radio frequency communications. The radio interface layer 1372 facilitates wireless connectivity between the system 1300 and the “outside world,” via a communications carrier or service provider. Transmissions to and from the radio interface layer 1372 are conducted under control of the operating system 1364. In other words, communications received by the radio interface layer 1372 may be disseminated to the application programs 1366 via the operating system 1364, and vice versa.

The visual indicator 1320 may be used to provide visual notifications, and/or an audio interface 1374 may be used for producing audible notifications via the audio transducer 1325. In the illustrated example, the visual indicator 1320 is a light emitting diode (LED) and the audio transducer 1325 is a speaker. These devices may be directly coupled to the power supply 1370 so that when activated, they remain on for a duration dictated by the notification mechanism even though the processor 1360 and other components might shut down for conserving battery power. The LED may be programmed to remain on indefinitely until the user takes action to indicate the powered-on status of the device. The audio interface 1374 is used to provide audible signals to and receive audible signals from the user. For example, in addition to being coupled to the audio transducer 1325, the audio interface 1374 may also be coupled to a microphone to receive audible input, such as to facilitate a telephone conversation. In accordance with aspects of the present disclosure, the microphone may also serve as an audio sensor to facilitate control of notifications, as will be described below. The system 1300 may further include a video interface 1376 that enables an operation of an on-board camera 1330 to record still images, video stream, and the like.

It will be appreciated that system 1300 may have additional features or functionality. For example, system 1300 may also include additional data storage devices (removable and/or non-removable) such as, magnetic disks, optical disks, or tape. Such additional storage is illustrated in FIG. 13 by the non-volatile storage area 1368.

Data/information generated or captured and stored via the system 1300 may be stored locally, as described above, or the data may be stored on any number of storage media that may be accessed by the device via the radio interface layer 1372 or via a wired connection between the system 1300 and a separate computing device associated with the system 1300, for example, a server computer in a distributed computing network, such as the Internet. As should be appreciated, such data/information may be accessed via the radio interface layer 1372 or via a distributed computing network. Similarly, such data/information may be readily transferred between computing devices for storage and use according to any of a variety of data/information transfer and storage means, including electronic mail and collaborative data/information sharing systems.

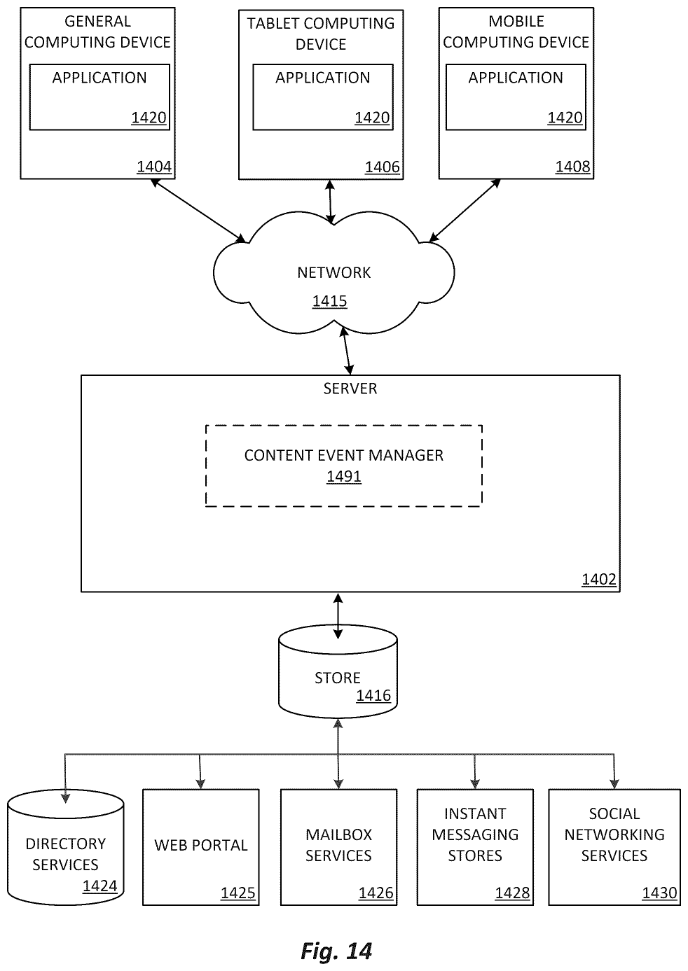

FIG. 14 illustrates one aspect of the architecture of a system for processing data received at a computing system from a remote source, such as a personal computer 1404, tablet computing device 1406, or mobile computing device 1408, as described above. Content displayed at server device 1402 may be stored in different communication channels or other storage types. For example, various documents may be stored using a directory service 1424, a web portal 1425, a mailbox service 1426, an instant messaging store 1428, or a social networking site 1430.

An application 1420 (e.g., similar to the application 1220) may be employed by a client that communicates with server device 1402. Additionally, or alternatively, a content event relevance determiner 1491 may be employed by server device 1402. The server device 1402 may provide data to and from a client computing device such as a personal computer 1404, a tablet computing device 1406 and/or a mobile computing device 1408 (e.g., a smart phone) through a network 1415. By way of example, the computer system described above may be embodied in a personal computer 1404, a tablet computing device 1406 and/or a mobile computing device 1408 (e.g., a smart phone). Any of these examples of the computing devices may obtain content from the store 1416, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The example systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the example aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for providing content events that are relevant to a first user of a social network is provided. The method includes obtaining content data associated with one or more content events, each of the one or more content events related to one or more second users within the social network, the first user connected with the one or more second users within the social network, obtaining user engagement data associated with the first user, the user engagement data indicative of interactions between the first user and content generated by one or more third users of the social network, determining a relevance score for each of the one or more content events using a relevance predictive model based on the user engagement data and attributes associated with the respective content event, the relevance score of each of the one or more content events representing a likelihood of the first user to engage with the respective content event, ranking the content events based on the relevance score for each of the one or more content events, and presenting a subset of the content events to the first user on a user interface of a device based on the ranking.

In accordance with at least one aspect of the above method, the method may further include where the content is distributed on multiple platforms associated with the social network. In accordance with at least one aspect of the above method, the method may further include where the one or more third users include the one or more second users.

In accordance with at least one aspect of the above method, the method may further include where the user engagement data includes connection strength between the first user and the one or more third users, and engagement by the first user with at least one content event related to a respective second user from the one or more content events increases in the connection strength between the first user and the respective second user.

In accordance with at least one aspect of the above method, the method may further include where the user engagement data includes at least one of a connection feature, a notification affinity feature, or a feed affinity feature, the connection features indicates connection strength between the first user and a respective user of the one or more third users, the notification affinity feature indicates interactions between the first user and one or more notifications generated by a respective user of the one or more third users, or the feed affinity feature indicates interactions between the first user and one or more feeds generated by a respective user of the one or more third users.

In accordance with at least one aspect of the above method, the method may further include where determining the relevance score for each of the one or more content events using the relevance predictive model based on the engagement data and attributes associated with the respective content event comprises determining one or more affinity scores based on the user engagement data, each affinity score indicating a connection affinity between the first user and a respective user of the one or more second users associated with the one or more content events, and determining the relevance score for each of the one or more content events using the relevance predictive model based on the one or more affinity scores and the attributes associated with the respective content event.

In accordance with at least one aspect of the above method, the method may further include where the affinity score between the first user and the respective second user increases as activities between the first user and the respective second user increases.

In accordance with at least one aspect of the above method, the method may further include where each of the subset of the content events satisfies or exceeds a predetermined relevance threshold.

In accordance with at least one aspect of the above method, the method may further include setting a status flag of each content event of the subset of the content events to a first status, subsequent to presenting the subset of the content events to the first user, determining if one or more content events of the subset of the content events have been engaged with the first user, and in response to determining that the one or more content events of the subset of the content events have been engaged with the first user, changing the status flag of the one or more content events of the subset of the content events to a second status.

In accordance with at least one aspect of the above method, the method may further include storing a mapping between the first user and each of the subset of the content events in a user content database including the status flag and the ranking of the respective content event.

In accordance with at least one aspect of the above method, the method may further include receiving an indication that a subsequent content event related to at least one of the one or more second users is generated, and in response to receiving the indication of the subsequent content event, updating relevance scores of the content events using the relevance predictive model, the content events including the subsequent content event.

In accordance with at least one aspect of the above method, the method may further include where the content data includes offline data and nearline data associated with at least one content event, the offline data are generated via batch offline processing, and the nearline data are processed on data streams in near real-time.

In accordance with at least one aspect of the above method, the method may further include where the attributes associated with the respective content event indicate at least one of close proximity to an approaching date associated with the respective content event or include a type of the content event associated with the respective content event.

In accordance with at least one aspect of the above method, the method may further include where obtaining the content data associated with the one or more content events comprises obtaining user data associated with the first user, wherein the user data includes a profile of the first user on the social network and activities of the first user on the social network and indicates an objective of the first user, and selecting a subset of the one or more content events based on a type of the one or more content events and the objective of the first user using a machine learning model.

In accordance with at least one aspect of the above method, the method may further include continuously obtaining subsequent user engagement data associated with the first user to update the ranking of the content events.

In accordance with at least one example of the present disclosure, a computing device for providing content events that are relevant to a first user of a social network is provided. The computing device may include a processor and a memory having a plurality of instructions stored thereon that, when executed by the processor, causes the computing device to obtain content data associated with one or more content events, each of the one or more content events related to one or more second users within the social network, the first user connected with the one or more second users within the social network, obtain user engagement data associated with the first user, the user engagement data indicative of interactions between the first user and content generated by one or more third users of the social network, determine a relevance score for each of the one or more content events using a relevance predictive model based on the user engagement data and attributes associated with the respective content event, the relevance score of each of the one or more content events representing a likelihood of the first user to engage with the respective content event, rank the content events based on the relevance score for each of the one or more content events, and present a subset of the content events to the first user on a user interface of a device based on the ranking.

In accordance with at least one aspect of the above computing device, the computing device may comprise where to determine the relevance score for each of the one or more content events using the relevance predictive model based on the user engagement data and attributes associated with the respective content event comprises to determine one or more affinity scores based on the user engagement data, each affinity score indicating a connection affinity between the first user and a respective user of the one or more second users associated with the one or more content events, and determine the relevance score for each of the one or more content events using the relevance predictive model based on the one or more affinity scores and the attributes associated with the respective content event.

In accordance with at least one aspect of the above computing device, the computing device may comprise where the content data includes offline data and nearline data associated with at least one content event, the offline data are generated via batch offline processing, and the nearline data are processed on data streams in near real-time, the user engagement data includes at least one of a connection feature, a notification affinity feature, or a feed affinity feature, the connection features indicates connection strength between the first user and a respective user of the one or more third users, the notification affinity feature indicates interactions between the first user and one or more notifications generated by a respective user of the one or more third users, or the feed affinity feature indicates interactions between the first user and one or more feeds generated by a respective user of the one or more third users, and the attributes associated with the respective content event indicate at least one of close proximity to an approaching date associated with the respective content event or include a type of the content event associated with the respective content event.

In accordance with at least one example of the present disclosure, a non-transitory computer-readable medium storing instructions for providing content events that are relevant to a first user of a social network is provided. The instructions when executed by one or more processors of a computing device, cause the computing device to obtain content data associated with one or more content events, each of the one or more content events related to one or more second users within the social network, the first user connected with the one or more second users within the social network, obtain user engagement data associated with the first user, the user engagement data indicative of interactions between the first user and content generated by one or more third users of the social network, determine a relevance score for each of the one or more content events using a relevance predictive model based on the user engagement data and attributes associated with the respective content event, the relevance score of each of the one or more content events representing a likelihood of the first user to engage with the respective content event, rank the content events based on the relevance score for each of the one or more content events, and present a subset of the content events to the first user on a user interface of a device based on the ranking.

In accordance with at least one aspect of the above non-transitory computer-readable medium, the instructions when executed by one or more processors of a computing device may include where to determine the relevance score for each of the one or more content events using the relevance predictive model based on the user engagement data and attributes associated with the respective content event comprises to determine one or more affinity scores based on the user engagement data, each affinity score indicating a connection affinity between the first user and a respective user of the one or more second users associated with the one or more content events, and determine the relevance score for each of the one or more contents event using the relevance predictive model based on the one or more affinity scores and the attributes associated with the respective content event.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

What is claimed is:

1. A method for providing content events that are relevant to a first user of a social network, the method comprising:
obtaining content data associated with one or more content events, each of the one or more content events related to one or more second users within the social network, the first user connected with the one or more second users within the social network;
obtaining user engagement data associated with the first user, the user engagement data indicative of interactions between the first user and content generated by one or more third users of the social network;
determining a relevance score for each of the one or more content events using a relevance predictive model based on the user engagement data and attributes associated with the respective content event, the relevance score of each of the one or more content events representing a likelihood of the first user to engage with the respective content event;
ranking the content events based on the relevance score for each of the one or more content events; and
presenting a subset of the content events to the first user on a user interface of a device based on the ranking.

2. The method of claim 1, wherein the content is distributed on multiple platforms associated with the social network.

3. The method of claim 1, wherein the one or more third users include the one or more second users.

4. The method of claim 3, wherein the user engagement data includes connection strength between the first user and the one or more third users, and engagement by the first user with at least one content event related to a respective second user from the one or more content events increases in the connection strength between the first user and the respective second user.

5. The method of claim 1, wherein the user engagement data includes at least one of a connection feature, a notification affinity feature, or a feed affinity feature, the connection features indicates connection strength between the first user and a respective user of the one or more third users, the notification affinity feature indicates interactions between the first user and one or more notifications generated by a respective user of the one or more third users, or the feed affinity feature indicates interactions between the first user and one or more feeds generated by a respective user of the one or more third users.

6. The method of claim 1, wherein determining the relevance score for each of the one or more content events using the relevance predictive model based on the engagement data and attributes associated with the respective content event comprises:
determining one or more affinity scores based on the user engagement data, each affinity score indicating a connection affinity between the first user and a respective user of the one or more second users associated with the one or more content events; and
determining the relevance score for each of the one or more content events using the relevance predictive model based on the one or more affinity scores and the attributes associated with the respective content event.

7. The method of claim 6, wherein the affinity score between the first user and the respective second user increases as activities between the first user and the respective second user increases.

8. The method of claim 1, wherein each of the subset of the content events satisfies or exceeds a predetermined relevance threshold.

9. The method of claim 1, further comprising:
setting a status flag of each content event of the subset of the content events to a first status;
subsequent to presenting the subset of the content events to the first user, determining if one or more content events of the subset of the content events have been engaged with the first user; and
in response to determining that the one or more content events of the subset of the content events have been engaged with the first user, changing the status flag of the one or more content events of the subset of the content events to a second status.

10. The method of claim 9, further comprising:
storing a mapping between the first user and each of the subset of the content events in a user content database including the status flag and the ranking of the respective content event.

11. The method of claim 1, further comprising:
receiving an indication that a subsequent content event related to at least one of the one or more second users is generated; and
in response to receiving the indication of the subsequent content event, updating relevance scores of the content events using the relevance predictive model, the content events including the subsequent content event.

12. The method of claim 1, wherein the content data includes offline data and nearline data associated with at least one content event, the offline data are generated via batch offline processing, and the nearline data are processed on data streams in near real-time.

13. The method of claim 1, wherein the attributes associated with the respective content event indicate at least one of close proximity to an approaching date associated with the respective content event or include a type of the content event associated with the respective content event.

14. The method of claim 1, wherein obtaining the content data associated with the one or more content events comprises:
obtaining user data associated with the first user, wherein the user data includes a profile of the first user on the social network and activities of the first user on the social network and indicates an objective of the first user; and
selecting a subset of the one or more content events based on a type of the one or more content events and the objective of the first user using a machine learning model.

15. The method of claim 1, further comprising:
continuously obtaining subsequent user engagement data associated with the first user to update the ranking of the content events.

16. A computing device for providing content events that are relevant to a first user of a social network, the computing device comprising:
a processor; and
a memory having a plurality of instructions stored thereon that, when executed by the processor, causes the computing device to:
obtain content data associated with one or more content events, each of the one or more content events related to one or more second users within the social network, the first user connected with the one or more second users within the social network;
obtain user engagement data associated with the first user, the user engagement data indicative of interactions between the first user and content generated by one or more third users of the social network;
determine a relevance score for each of the one or more content events using a relevance predictive model based on the user engagement data and attributes associated with the respective content event, the relevance score of each of the one or more content events representing a likelihood of the first user to engage with the respective content event;
rank the content events based on the relevance score for each of the one or more content events; and
present a subset of the content events to the first user on a user interface of a device based on the ranking.

17. The computing device of claim 16, wherein to determine the relevance score for each of the one or more content events using the relevance predictive model based on the user engagement data and attributes associated with the respective content event comprises to:
determine one or more affinity scores based on the user engagement data, each affinity score indicating a connection affinity between the first user and a respective user of the one or more second users associated with the one or more content events; and
determine the relevance score for each of the one or more content events using the relevance predictive model based on the one or more affinity scores and the attributes associated with the respective content event.

18. The computing device of claim 16, wherein:
the content data includes offline data and nearline data associated with at least one content event, the offline data are generated via batch offline processing, and the nearline data are processed on data streams in near real-time,
the user engagement data includes at least one of a connection feature, a notification affinity feature, or a feed affinity feature, the connection features indicates connection strength between the first user and a respective user of the one or more third users, the notification affinity feature indicates interactions between the first user and one or more notifications generated by a respective user of the one or more third users, or the feed affinity feature indicates interactions between the first user and one or more feeds generated by a respective user of the one or more third users, and
the attributes associated with the respective content event indicate at least one of close proximity to an approaching date associated with the respective content event or include a type of the content event associated with the respective content event.

19. A non-transitory computer-readable medium storing instructions for providing content events that are relevant to a first user of a social network, the instructions when executed by one or more processors of a computing device, cause the computing device to:
obtain content data associated with one or more content events, each of the one or more content events related to one or more second users within the social network, the first user connected with the one or more second users within the social network;
obtain user engagement data associated with the first user, the user engagement data indicative of interactions between the first user and content generated by one or more third users of the social network;
determine a relevance score for each of the one or more content events using a relevance predictive model based on the user engagement data and attributes associated with the respective content event, the relevance score of each of the one or more content events representing a likelihood of the first user to engage with the respective content event;
rank the content events based on the relevance score for each of the one or more content events; and
present a subset of the content events to the first user on a user interface of a device based on the ranking.

20. The non-transitory computer-readable medium of claim 19 wherein to determine the relevance score for each of the one or more content events using the relevance predictive model based on the user engagement data and attributes associated with the respective content event comprises to:
determine one or more affinity scores based on the user engagement data, each affinity score indicating a connection affinity between the first user and a respective user of the one or more second users associated with the one or more content events; and
determine the relevance score for each of the one or more contents event using the relevance predictive model based on the one or more affinity scores and the attributes associated with the respective content event.
